(19) United States
(12) Patent Application Publication
(10) Pub. No.: US 2012/0254357 A1
(43) Pub. Date: Oct. 4, 2012

(54) SERVER, REPRODUCTION APPARATUS, AND INFORMATION REPRODUCTION SYSTEM

(75) Inventors: Yoshio KAWAKAMI, Osaka (JP); Masahiro Oashi, Yamanashi (JP); Yasushi Waki, Kyoto (JP)

(73) Assignee: Panasonic Corporation, Osaka (JP)

(21) Appl. No.: 13/489,044

(22) Filed: Jun. 5, 2012

Related U.S. Application Data
(63) Continuation of application No. PCT/JP2010/006876, filed on Nov. 25, 2010.

(30) Foreign Application Priority Data
Dec. 7, 2009 (JP) 2009-277904

(51) Int. Cl. G06F 15/16

(52) U.S. Cl. 709/217

(57) ABSTRACT

A link server according to an embodiment of the present invention includes: a service data obtaining unit that obtains first data having a first format, from an external service server that provides data stored in a database, through an electric telecommunication line; a data converting unit that converts the first data into second data having a second format available to a program that operates on a reproduction apparatus; and a communication control unit that transmits the second data resulting from the conversion performed by the data converting unit, to the program that operates on the reproduction apparatus.

### CROSS REFERENCE TO RELATED APPLICATIONS

This is a continuation application of PCT Patent Application No. PCT/JP2010/006876 filed on Nov. 25, 2010, designating the United States of America, which is based on and claims priority of Japanese Patent Application No. 2009-277904 filed on Dec. 7, 2009. The entire disclosures of the above-identified applications, including the specifications, drawings and claims are incorporated herein by reference in their entirety.

### TECHNICAL FIELD

The present invention relates to a technique for easily adding a net service reproducible by consumer electronics (CE) devices.

### BACKGROUND ART

In general, the CE devices have less hardware resources such as CPU performance and memory capacity, compared to personal computers (PC). Accordingly, in order for an application which operates on the PC to operate on the CE device, it is generally necessary to reduce necessary hardware resources by taking measures such as reducing functions of the application and decreasing versatility.

Even among such CE devices, a reproduction apparatus provided with a BD (Blu-ray Disc)-ROM reproduction function including the Java® Virtual Machine has been widely spread in recent years. It is therefore conceivable that the CE devices provide the performance sufficient for operating the Java® Virtual Machine. However, given that the CE devices having the function equivalent to the HTML (Hyper Text Markup Language) browser that operates on the PC are not widely spread, it generally is not conceivable that the CE devices provide the performance sufficient for implementing the HTML browser that operates on the PC.

In recent years, the services have been popular which provide such functions as distributing and sharing video, music, photographs, and the like through the Internet, using the functions of the HTML browser that operates on the PC and a program that operates in collaboration with the HTML browser that is generally called a plug-in or an add-on (hereinafter referred collectively to as net services). When the net services for the PCs are to be implemented on the CE devices, it is difficult for the HTML browser and the plug-in that operate on the PCs to operate as they stand or for the program having equivalent functions to operate on the CE devices in view of the hardware resources as described above. Thus, an approach different from the reproduction on the PC is required. To be specific, instead of using the HTML browser, a dedicated program for reproducing a given net service is caused to operate on the CE device. The dedicated program directly communicate with a server that provides the net service (hereinafter referred to as a service server), thereby implementing the net service. In addition, the dedicated program is specialized in implementation of the net service, and thus it is possible to reduce the necessary hardware resource to the minimum. Accordingly, such a dedicated program can be executed on the CE device as well.

Other implementation methods include a method that uses the technique described in Patent Literature 1. More specifically, a simple HTML browser that can operate on the CE device is prepared for the CE device. The HTML browser does not directly communicate with the service server but once accesses to a server called a link server. The link server communicates with the service server, and extracts only a piece of information that can be processed by the HTML browser on the CE device, from among pieces of information provided by the service server. The extracted piece of information includes the URL (Uniform Resource Locator) directly indicating the data of video, music, or the like provided by the service server. The simple HTML browser that operates on the CE device directly acquires, based on the URL, the data such as video, music, or the like from the service server. This makes it possible to reproduce the data on the CE device.

### CITATION LIST

### Patent Literature

[PTL] Japanese Unexamined Patent Application Publication No. 2003-77222

### SUMMARY OF INVENTION

### Technical Problem

When a net service is reproduced by the above-described dedicated program, the number of the dedicated programs increases as the number of types of the net services corresponding to a given CE device increases. However, it is generally difficult for the CE device to continue to correspond to a large number of net services because only a limited number of programs can be mounted due to insufficient hardware resources, and because the development costs and the support costs continue to increase.

In addition, when the technique of the Patent Literature 1 is used, although the above-described problem can be solved, functions provided by the service server are deleted by routing through the link server. The functions include the function of obtaining and retrieving information other than the information directly indicating data such as video and music, that is, additional information for the data such as a commentary and the number of viewed times, and the function of posting comments. For this reason, only a small part of the functions which are originally provided by the net service is provided on the CE device.

In view of the above, an object of the present invention is to provide a server, a reproduction apparatus, and an information reproduction system which allow implementation of the net service on a reproduction apparatus which has insufficient hardware resources.

### Solution to Problem

In order to solve the above-stated problems, a server according to an embodiment of the present disclosure includes: an information obtaining unit configured to obtain first data having a first format from an external server that provides, through an electric telecommunication line, data stored in a database; an information conversion unit configured to convert the first data into second data having a second format that is available to a program that operates on a reproduction apparatus; and an information transmitting unit configured to transmit, to the program that operates on the reproduction apparatus, the second data resulting from the conversion performed by the information conversion unit.

According to the configuration described above, it is possible to convert data provided by an external server into another format so as to be transmitted to the reproduction apparatus. Thus, the server according to an aspect of the present invention can implement a net service on the reproduction apparatus which has insufficient hardware resources.

In addition, the information conversion unit may convert, into the second data having the second format, data having a plurality of different formats which include the first format.

According to the configuration described above, when plural external servers provide data, or when a single external server provides data in plural formats, the server according to an aspect of the present invention can convert such data into data in a format reproducible by the reproduction apparatus. Thus, the reproduction apparatus can reproduce data of the format that is originally plural in number.

In addition, it may be possible that data having the first format cannot be reproduced by the reproduction apparatus and data having the second format can be reproduced by the reproduction apparatus.

According to the configuration described above, data that cannot be reproduced by the reproduction apparatus is converted into reproducible data, and thus the data can be reproduced by the reproduction apparatus.

In addition the server may further include a request receiving unit configured to receive a request from the program that operates on the reproduction apparatus, wherein, according to the request received by the request receiving unit: the information obtaining unit may obtain the first data from the external server; the information conversion unit may convert the first data into the second data; and the information transmitting unit may transmit the second data to the program.

According to the configuration described above, the server according to an aspect of the present invention can transmit necessary information to the reproduction apparatus in response to a request from the reproduction apparatus.

In addition the server may further include an information storage for storing and retrieving data, wherein the server may store, into the information storage, the second data resulting from the conversion performed by the information conversion unit.

According to the configuration described above, the server according to an aspect of the present invention can hold information obtained from an external server.

In addition the server may further include a request receiving unit configured to receive a request from the program, wherein (i) when the second data specified by the request received by the request receiving unit is stored in the information storage, the information transmitting unit may transmit, to the program that operates on the reproduction apparatus, the second data stored in the information storage, and (ii) when the second data specified by the request received by the request receiving unit is not stored in the information storage: the information obtaining unit may obtain the first data from the external server; the information conversion unit may convert the first data into the second data; and the information transmitting unit may transmit, to the program that operates on the reproduction apparatus, the second data resulting from the conversion performed by the information conversion unit.

According to the configuration described above, when there is information stored in advance in response to a request from the reproduction apparatus, the server according to an aspect of the present invention can immediately respond to the reproduction apparatus.

In addition, a reproduction apparatus comprising according to an embodiment of the present disclosure includes: a program executing unit configured to execute a program for receiving second data having a second format through an electric telecommunication line from a server that converts first data having a first format into the second data, the first data being obtained, by the server, from an external server through the electric telecommunication line; a communication unit configured to transmit and receive information to and from the external server connected through the electric telecommunication line, based on an instruction from the program executed by the program executing unit; and a display unit configured to construct a display image to be presented to a user, based on the instruction from the program executed by the program executing unit.

According to the configuration described above, it is possible to execute, on the reproduction apparatus, a program for reproducing data resulting from the conversion performed by the server, so as to indirectly reproduce data that is provided by an external server. Thus, the reproduction apparatus according to an aspect of the present invention can implement a net service on the reproduction apparatus which has insufficient hardware resources.

In addition, the program may be written in an abstract language independent of a configuration of the reproduction apparatus, and the program executing unit may include a virtual machine capable of executing a program written in the language.

According to the configuration described above, it is possible to execute the program on a variety of reproduction apparatuses, without porting the program.

In addition, the reproduction apparatus may further include an error notification unit configured to notify the program of failure in properly displaying the display image when the display unit fails to properly display the display image.

According to the configuration described above, it is possible, using the program, to take measures such as informing a user, trying a different reproduction means, and so on, when failed in reproduction. In addition, the reproduction apparatus may further include a performance information providing unit configured to provide the program with information related to performance of the reproduction apparatus.

According to the configuration described above, it is possible, using the program, to determine whether or not reproduction succeeds prior to performing the reproduction, by knowing in advance the performance of the reproduction apparatus.

In addition, the reproduction apparatus may further include a program updating unit configured to replace the program stored in the reproduction apparatus with an other program when the program is updated.

According to the configuration described above, it is possible to update a program that operates on the reproduction apparatus.

In addition, the reproduction apparatus may further include an information holding unit configured to hold, in the reproduction apparatus, information transmitted by the program.

According to the configuration described above, it is possible, using the program, to hold arbitrary information in the reproduction apparatus. For example, it is possible, using the program, to hold information such as usage history and change of settings in the reproduction apparatus, thereby enabling the information to be used for the next activation.

In addition, the reproduction apparatus may further include a data storage which stores, in the reproduction apparatus, data obtained from the external server.

According to the configuration described above, the reproduction apparatus according to an aspect of the present invention is capable of skipping the obtainment of data after the first obtainment, and thus it is possible to reduce the amount of time taken for reproduction.

In addition, the reproduction apparatus may further include a specific information providing unit configured to supply the program with specific information held by the reproduction apparatus, the specific information being for identifying a difference between the reproduction apparatus and an other reproduction apparatus.

According to the configuration described above, it is possible, using the program, to change a process according to obtained specific information. Thus, it is possible to implement a different operation for each reproduction apparatus.

In addition, a second program different from the program may be further held in the reproduction apparatus, and the reproduction apparatus may further include a second program executing unit configured to execute the second program based on the instruction from the program.

According to the configuration described above, it is possible, using the program, to transfer the function which cannot be processed by the program itself, to a different program, by activating an external program.

In addition, an information reproduction system according o an embodiment of the present disclosure includes: a first server which stores data in a database and provides, through an electric telecommunication line, first data having a first format and stored in the database; a second server which converts the first data into second data having a second format and provides the second data, the first data being obtained, by the server, from the first server through the electric telecommunication line; and a reproduction apparatus which reproduces data obtained from the first server, using data obtained, by the server, from the second server, wherein the reproduction apparatus includes a program executing unit configured to cause a program to operate, the program being for communicating with the first server and the second server and issuing an instruction on image display.

According to the configuration described above, it is possible for the reproduction apparatus which has insufficient hardware resources to support a large number of net services.

It is to be noted that the present invention can be implemented, in addition to implementation as a server, a reproduction apparatus, and an information reproduction system, as an information providing method, a reproduction method, or an information reproduction method, including characteristic units included in the server, the reproduction apparatus, and the information reproduction system as steps, or as a program which, when loaded into a computer, allows a computer to execute the characteristic steps. It goes without saying that the program as described above can be distributed via a non-transitory computer-readable recording medium such as a CD-ROM, and a communication network such as the Internet.

Furthermore, the present invention can be implemented as a semiconductor integrated circuit (LSI) that implements some or all of the functions of the server or the reproduction apparatus.

### Advantageous Effects of Invention

According to the present invention, when it is desired that a CE device having existing performance supports a large number of net services, it is possible to easily increase reproducible net services and follow the changes without continuous increase in necessary hardware resources and costs in proportion to the number of net services supported by the CE device.

### BRIEF DESCRIPTION OF DRAWINGS

These and other objects, advantages and features of the invention will become apparent from the following description thereof taken in conjunction with the accompanying drawings that illustrate a specific embodiment of the present invention. In the Drawings:

FIG. 1 is a diagram illustrating a home theatre system as an example of an embodiment of a utilization form of an information reproduction apparatus according to Embodiment 1 of the present invention;

FIG. 2 is a diagram schematically illustrating a system configuration of a net service reproduction system according to Embodiment 1 of the present invention;

FIG. 3 is a diagram schematically illustrating an internal configuration of a reproduction apparatus according to Embodiment 1 of the present invention;

FIG. 4 is a diagram schematically illustrating an example of the internal configuration of a link server according to Embodiment 1 of the present invention;

FIG. 5 is a diagram illustrating an example of a format of data that can be interpreted by a net service application according to Embodiment 1 of the present invention;

FIG. 6 is a diagram illustrating an example of a format of data which is provided by a service server and which cannot be interpreted by the net service application, according to Embodiment 1 of the present invention;

FIG. 7 is a diagram illustrating an example of a format of data that can be interpreted by the net service application according to Embodiment 1 of the present invention;

FIG. 8 is a diagram schematically illustrating an example of the configuration of data which is managed by the data managing unit of the link server and stored in a storage, according to Embodiment 1 of the present invention;

FIG. 9 is a diagram schematically illustrating an example of the internal configuration of a service server according to Embodiment 1 of the present invention;

FIG. 10 is a diagram schematically illustrating an example of the internal configuration of the net service application executed by an application executing unit in the reproduction apparatus according to Embodiment 1 of the present invention;

FIG. 11 is a diagram illustrating an example of a display on a display according to Embodiment 1 of the present invention;

FIG. 12 is a diagram illustrating an example of a display on the display according to Embodiment 1 of the present invention;

FIG. 13 is a diagram illustrating an example of a display on the display according to Embodiment 1 of the present invention;

FIG. 14 is a flowchart illustrating processes performed by the net service reproduction system according to Embodiment 1 of the present invention;

FIG. 15 is a flowchart illustrating processes performed by the net service reproduction system according to Embodiment 1 of the present invention;

FIG. 16 is a flowchart illustrating the processing of obtaining, from the service server, a content that a user desires to reproduce, and reproducing the obtained content at the reproduction apparatus;

FIG. 17 is a flowchart illustrating processes when the net service application according to Embodiment 1 of the present invention uses video search using a keyword via a video searching function provided by the link server;

FIG. 18 is a diagram illustrating a configuration of a BD-ROM according to Embodiment 1 of the present invention;

FIG. 19 is a diagram illustrating an internal configuration of an AV reproduction control unit according to Embodiment 2 of the present invention;

FIG. 20 is a diagram illustrating an internal configuration of a net service application according to Embodiment 2 of the present invention;

FIG. 21 is a diagram illustrating an internal configuration of a reproduction apparatus according to Embodiment 3 of the present invention;

FIG. 22 is a diagram illustrating an internal configuration of a net service application according to Embodiment 3 of the present invention;

FIG. 23 is a diagram illustrating an internal configuration of a link server according to Embodiment 5 of the present invention;

FIG. 24 is a diagram illustrating an internal configuration of a net service application according to Embodiment 5 of the present invention;

FIG. 25 is a diagram illustrating an internal configuration of a reproduction apparatus according to Embodiment 7 of the present invention;

FIG. 26 is a diagram illustrating an internal configuration of a reproduction apparatus according to Embodiment 8 of the present invention; and

FIG. 27 is a diagram illustrating an internal configuration of a reproduction apparatus according to Embodiment 10 of the present invention.

### DESCRIPTION OF EMBODIMENTS

The following describes embodiments of the present invention with reference to the drawings.

### Embodiment 1

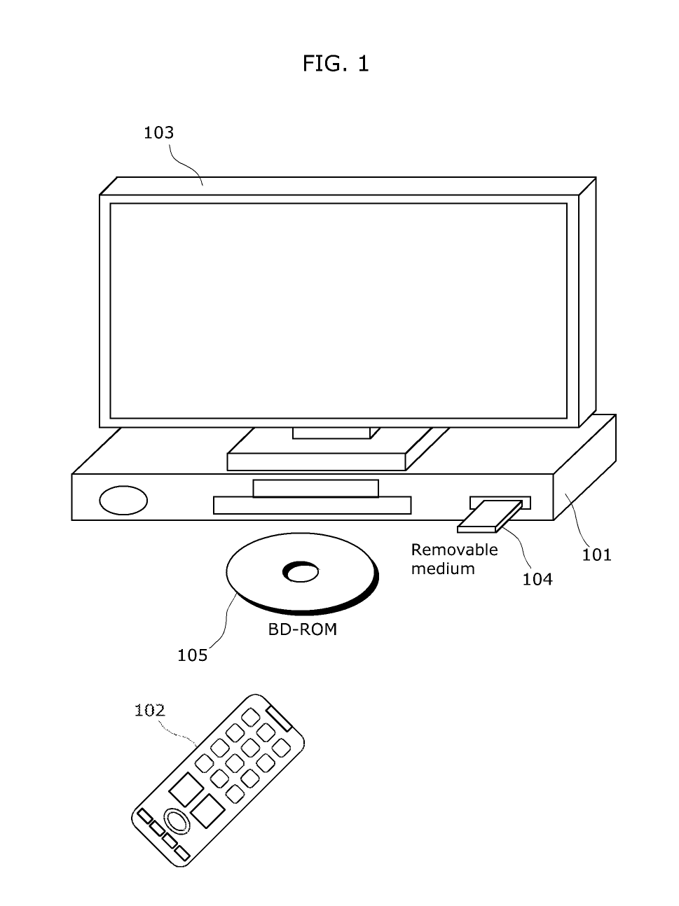

FIG. 1 is a diagram illustrating a home theatre system as an example of an embodiment of a utilization form of a net service reproduction apparatus according to Embodiment 1 of the present invention. The home theatre system in the diagram includes: a reproduction apparatus 101; a remote controller 102; a display 103; a removable medium 104; and a recording medium 105. Here, the reproduction apparatus 101 corresponds to the net service reproduction apparatus according to the present invention. It is to be noted that the display 103 may be a part of the net service reproduction apparatus according to the present invention.

The reproduction apparatus 101 is used for supplying the home theatre system with a film work. The reproduction apparatus 101, for example, obtains a movie content and so on from the removable medium 104, the recording medium 105, the Internet, or the like.

Then, the reproduction apparatus 101 displays a video on the display 103 according to an instruction from the remote controller 102 or the like, and outputs audio from a speaker or the like (not illustrated). It is to be noted that the reproduction apparatus 101 includes: a receiving unit which receives a signal from the remote controller 102; an insertion opening into which the removable medium 104 is inserted; and an insertion opening into which the recording medium 105 is inserted.

The remote controller 102 includes a variety of buttons and transmits an instruction from a user to the reproduction apparatus 101 and the display 103.

The display 103 displays a video processed by the reproduction apparatus 101. In addition, the display 103 is provided with a speaker (not illustrated) and outputs audio processed by the reproduction apparatus 101. It is to be noted that the speaker may be included by the reproduction apparatus 101.

The removable medium 104 is, for example, an SD memory card, a memory stick, a compact flash®, a smart media, a multimedia card, and the like.

The recording medium 105 is an optical recording medium such as a BD-ROM, a BD-R (Blu-ray Disc Recordable), and a BD-RE (Blu-ray Disc Rewritable). The recording medium 105 records video and audio data of a movie content or the like. It is to be noted that the recording medium 105 may be a DVD-ROM and a CD-ROM.

As described above, the net service reproduction apparatus according to Embodiment 1 of the present invention is used for a home theatre system that is an example of the information reproduction system.

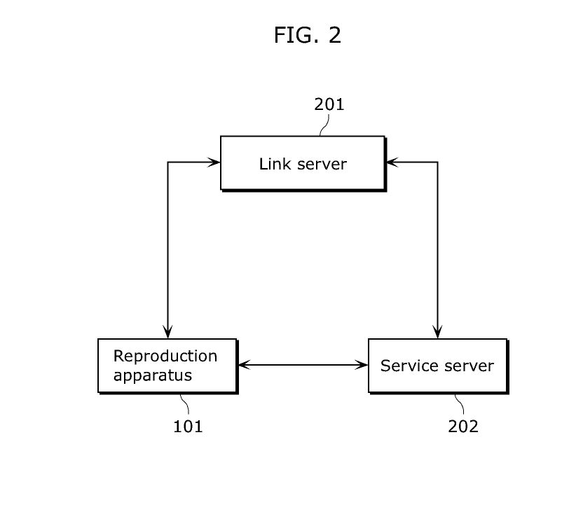

FIG. 2 is a diagram schematically illustrating a system configuration of the net service reproduction system that is an example of the information reproduction system according to Embodiment 1 of the present invention. The reproduction apparatus 101, the link server 201, and the service server 202 are capable of mutually transmitting information through a signal line typified by the Internet. It is to be noted that, in the following description, the link server 201 or the service server 202, or both of them collectively, may be simply referred to as a server.

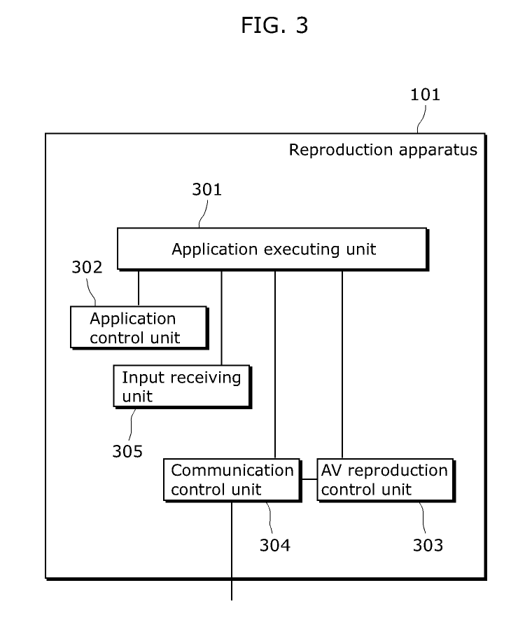

FIG. 3 is a diagram schematically illustrating an internal configuration of the reproduction apparatus 101 according to Embodiment 1 of the present invention.

As illustrated in FIG. 3, the reproduction apparatus 101 includes: an application executing unit 301; an application control unit 302; an AV reproduction control unit 303; a communication control unit 304; and an input receiving unit 305.

The application executing unit 301 corresponds to a program executing unit according to an embodiment of the present invention, and aims to cause an application for providing a net service (hereinafter referred to as a net service application, or simply referred to as an application) to operate. The net service application is a program which operates on the reproduction apparatus 101 and communicates with the link server 201 and the service server 202, and aims to perform display on the display 103 and to perform processing in response to an operation by the remote controller 102. This program is written in an abstract language which is independent of the configuration of the reproduction apparatus 101. When the net service application is a program written in the Java® language, for example, the application executing unit 301 includes a Java® Virtual Machine. In addition, when the net service application is a program written in the Flash®, the application executing unit 301 includes a Flash® reproduction engine.

The application control unit 302 controls the life cycle such as activation or end of the net service application that operates on the application executing unit 301. More specifically, the application control unit 302 provides the application executing unit 301 with an instruction such as activating or ending a given net service application. Then the application executing unit 301 follows the instruction and activates or ends the net service application.

The AV reproduction control unit 303 corresponds to a display unit according to an embodiment of the present invention, receives an instruction issued by the net service application, such as graphics drawing and AV (Audio Visual) data reproduction, and creates video to be displayed on the display 103, based on the details of the instruction. One method of issuing an instruction to the AV reproduction control unit 303, which is performed by the net service application, is a method to provide API (Application Programming Interface) available for the net service application, from the net service application to the AV reproduction control unit 303. For example, an embodiment of the present invention can be implemented using a known technique such as Java®, AWT (Abstract Window Toolkit), and Direct FB in the case of the graphics drawing, and JMF (Java Media Framework) in the case of the AV data reproduction. It is to be noted that the embodiment of the present invention can be implemented using any means, as long as the net service application is capable of transmitting, to the AV reproduction control unit 303, what should be reproduced.

The communication control unit 304 corresponds to a communication unit according to an embodiment of the present invention, and performs control for connecting the reproduction apparatus 101 with a communication line connected to the outside such as the Internet. To be specific, the communication control unit 304, based on an instruction from the application or the AV reproduction control unit 303, controls transmitting and receiving of information performed between an external device and the reproduction apparatus 101 which are connected through the communication line.

The input receiving unit 305 receives a signal from an input device typified by the remote controller 102, and transmits the details that are received, to the net service application that is caused to operate by the application executing unit 301. It is to be noted that the present invention can be implemented by not only the method in which the remote controller 102 is used, but also any method as long as the instruction from the user can be received.

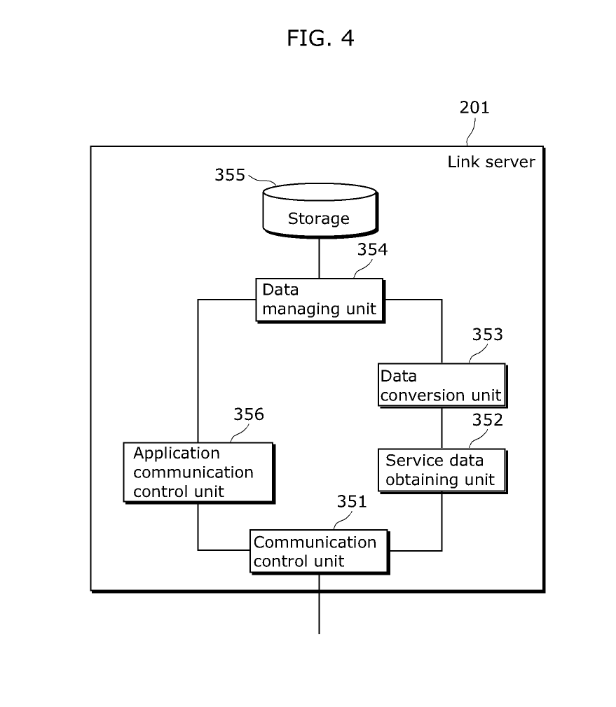

FIG. 4 is a diagram schematically illustrating an example of the internal configuration of the link server 201 according to Embodiment 1 of the present invention.

The link server 201 as illustrated in FIG. 4 includes: a communication control unit 351; a service data obtaining unit 352; a data conversion unit 353; a data managing unit 354; a storage 355; and an application communication control unit 356.

The communication control unit 351 corresponds to an information transmitting unit transmitting unit according to an embodiment of the present invention, and performs control for connecting the link server 201 with a communication line connected to the outside such as the Internet. In addition, the communication control unit 351 controls transmitting and receiving of information performed between the link server 201 and an external device connected through the communication line, based on a request from the service data obtaining unit 352 or the application communication control unit 356. The service data obtaining unit 352 corresponds to an information obtaining unit according to an embodiment of the present invention, obtains, from the service server 202 that provides a given net service, data necessary for reproducing the net service on the CE device, and transmits the data to the data conversion unit 353. It is to be noted that the service data obtaining unit 352 knows the method of transmitting a request for at least one service server 202 and the method of obtaining data from the service server 202. Accordingly, in the case where the link server 201 needs some data to be obtained from the service server 202, the link server 201 sends a request to the service data obtaining unit 352, thereby obtaining the necessary data. In addition, use of the same mechanism makes it possible not only to obtain data but also to transmit data to a given service server 202. Whether it is obtaining data or transmitting data, they are the same in terms of transmitting and receiving data between the link server 201 and the service server 202. Accordingly, since the service data obtaining unit 352 knows the method of transmitting and receiving, it is possible to transmit the data.

The data conversion unit 353 corresponds to an information conversion unit according to an embodiment of the present invention, converts the data obtained by the service data obtaining unit 352 so as to have a format that can be interpreted by the net service application that operates on the CE device, and provides the data resulting from the conversion to the data managing unit 354. In addition, the data conversion unit 353 can also convert the data in the format that can be interpreted by another net service application into data in the format that can be interpreted by a given service server. More specifically, the data conversion unit 353 receives, directly or via the data managing unit 354, data from the net service application which is received by the application communication control unit 356. Then the data conversion unit 353 can also convert the received data into data in a format that can be interpreted by the given service server 202, and transmit the data resulting from the conversion to the service data obtaining unit 352. According to the configuration described above, the net service application, for example, can perform indirect request (for example, search or registration of information) to the given service server 202, by routing through the link server 201.

Here, a specific example of the conversion performed by the data conversion unit 353 will be described.

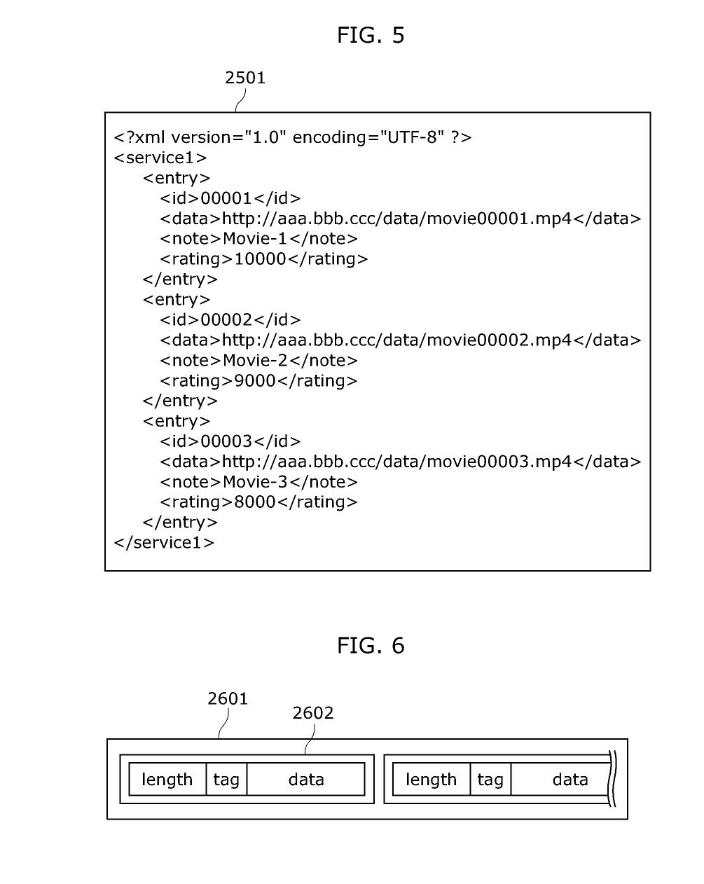

FIG. 5 is a diagram which illustrates an example of the format of data that can be interpreted by a net service application. As an example, an XML 2501 is assumed to be the data that can be received and interpreted by the net service application and written in the XML. The XML includes a total of three pieces of Movie information as details related to a content which has a service called “Service-1” and is of the type of “Movie”. One of the pieces of Movie information indicates that, for example, an identifier is “00001”, reference of data is “http://aaa.bbb.ccc/data/movie0001.mp4”, additional information is “Movie-1”, and Rating is “10000”. This data is used, for example, when the link server 201 responds to the net service application in response to a request, from the net service application to the link server 201, related to “information relates to the top three in Rating for video provided by the Service-1”

FIG. 6 is a diagram which illustrates an example of the format of data which is provided by a given service server 202 and which cannot be interpreted by a net service application.

Data 2601 includes data blocks 2602 which are sequentially aligned. Each of the data blocks 2602 includes “length” indicating a data length, “tag” for identifying which piece of information the block is, and “data” that indicates the details of the data. In the tag, “1” is specified when the following data includes an identifier of a content, and “2” is specified when the following data includes the reference of data, for example.

It is to be noted that the format of data provided by the service server 202 is not necessarily the format illustrated in FIG. 6, and an embodiment of the present invention can be implemented with any format as long as the format can be interpreted by the data conversion unit 353. In addition, when the link server 201 communicates with plural service servers 202, even when the format of data of each of the service servers 202 is different, an embodiment of the present invention can be implemented with any format as long as the data of each of the service servers 202 can be interpreted by the data conversion unit 353.

When the data provided by the service server 202 is written in the format of the data 2601, even if the data includes the amount of information equivalent to the amount of information of the XML 2501, the net service application cannot retrieve the details unless the net service application knows the configuration of the data 2601 and the meaning that relates to the details (for example, “when the tag is 1, the following data includes an identifier of the content” and so on). The data conversion unit 353 converts data such as the data 2601 which cannot be interpreted by the net service application into data such as the XML 2501 which can be interpreted by the net service application.

It is to be noted that, although it is desirable that the data conversion unit 353 converts the details included in the data provided by the service server 202 with no omission into data that can be interpreted by the net service application, the data conversion unit 353 may delete part of the data provided by the service server 202. On the other hand, the data conversion unit 353 may add information that is not included in data provided by the service server 202 for the sake of increasing convenience in the link server 201, to the data.

Next, a specific example of conversion performed by the data conversion unit 353 when the net service application issues a request to a given service server 202 will be described.

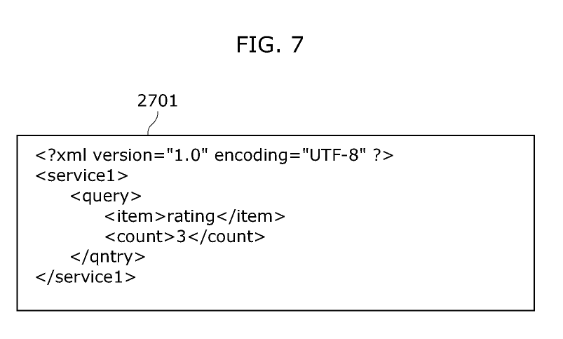

FIG. 7 is a diagram which illustrates an example of the format of data that can be interpreted by a net service application.

As an example, an XML 2701 is assumed to be the data which is transmitted to the link server 201 when the net service application issues a request to a given service server 202 and to be written in the XML. It is written, for the “service-1”, in the XML 2701 that the details relate to “query”, the item is “rating”, and the count is “3”. With this, the net service application is capable of transmitting, to the link server 201, a request that is “information related to the top three in the rating is desired from the net service of the service-1”. The format of the XML 2701 can be interpreted by at least the net service application and the link server 201; however, there is a case where the format of data that can be interpreted by the service server 202 is in a different format as illustrated in FIG. 6. In such a case, the link server 201 cannot transmit the details as they are to the service server 202. In view of the above, the data conversion unit 353 converts the details of the XML 2701 into the format of the data 2601 illustrated in FIG. 6. In this case, for example, a tag corresponding to the “query” in the XML 2701 may be “5”, and the following data may include “rating”.

It is to be noted that, although the XML 2501 and the XML 2701 are indicated as examples of the format that can be interpreted by the net service application, the format is not limited to the XML format and an embodiment of the present invention can be implemented with any format as long as the format can be interpreted by the net service application. For example, the format illustrated in FIG. 6 may be used, or the transmitting and receiving method of additional information used generally in the communication using HTTP may be used.

The data managing unit 354 stores, into the storage 355, data transmitted by the data conversion unit 353, and manages the data that is stored in the storage 355. In addition, the data managing unit 354 reads, from the storage 355, data which is requested from the application communication control unit 356, and transmits the read data to the application communication control unit 356.

The storage 355 corresponds to an information storage according to an embodiment of the present invention, stores data transmitted by the data managing unit 354, retrieves data according to a request from the data managing unit 354 to change or delete the data. This storage 355 can be implemented as long as being a medium capable of storing data, such as a hard disk, a non-volatile memory, and a volatile memory. In addition, the storage 355 does not have to be included in the link server 201 as long as the storage 355 can be used by the link server 201, and the storage 355 may be an external storing device connected to the link server 201.

The application communication control unit 356 corresponds to a request receiving unit according to an embodiment of the present invention, receives a request from a net service application that operates on the CE device, retrieves corresponding data from the data managing unit 354 if the request relates to obtaining data, and transmits the data to the net service application. In addition, in the case where it is desired that the link server 201 actively issues a request to the net service application, it is also possible to transmit the request to the net service application from the application communication control unit 356. Here, the case where it is desired that the link server 201 actively issues a request to the net service application is, for example, the case where it is desired to transmit a notification to the net service application when data related to the net service that is used is updated, or the case where it is desired to transmit a notification to the net service application when there is a change in the function or details provided by the net service.

According to these configurations as described above, the link server 201 can obtains data from the service server 202 corresponding to a predetermined net service, according to a request from the net service application that operates on the CE device, converts the data according to the format that can be used by the net service application, and transmits the data resulting from the conversion to the net service application.

It is to be noted that, in the link server 201, the service data obtaining unit 352 may obtain data in advance from the service server 202, the data conversion unit 353 may convert the obtained data, and the data managing unit 354 may store the data resulting from the conversion in the storage 355, in preparation for a request from the net service application without receiving the request from the net service application. According to the configuration described above, the link server 201 can respond immediately upon receiving a request from the net service application, without obtaining data from the service server 202.

In addition, only one net service may be supported by a single link server 201, or plural net services may be supported by a single link server 201. When plural net services are supported, units that constitute the link server 201 may be prepared for each of the net services, or may be shared.

When the plural net services are present, the method of obtaining data and the details of the obtained data (the format of the data, the type of information included in the data, and so on) are generally different for each of the net services. When supporting these plural net services by the single link server 201, for example, the service data obtaining unit 352 and the data conversion unit 353 are prepared for each of the net services. In addition, each of the data conversion units 353 converts data into a predetermined data format that can be used by a corresponding net service application that operates on the CE device. According to the configuration described above, the net service application that operates on the CE device can obtain information related to plural net services, by sending a request to only a single link server 201.

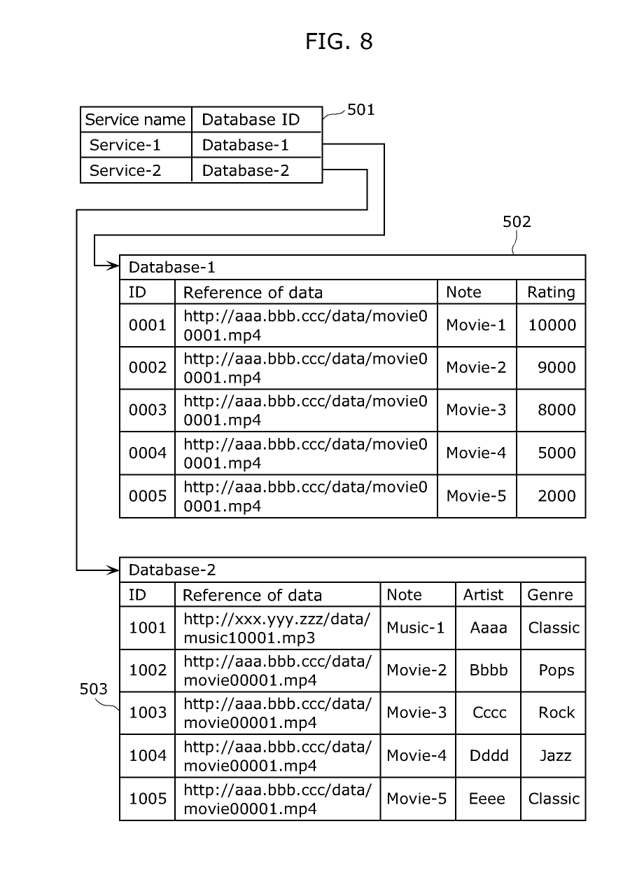

FIG. 8 is a diagram schematically illustrating an example of the configuration of data which is managed by the data managing unit 354 of the link server 201 and stored in the storage 355.

Here, a name (service name) allowing identifying each of the net services, such as “Service-1”, and information (database ID) for identifying a database for each of the services, such as “Database-1” are stored in the database 501. The database 502 is a database having a database ID “Database-1” corresponding to “Service-1”. The database 503 is a database having a database ID “Database-2” corresponding to “Service-2”.

The database 502 is a database managed by the data managing unit 354 based on the data obtained from the service server 202 corresponding to the Service-1. The database 502 includes an ID for identifying each of the contents, a URL which is a reference of data of each of the contents, Note which is additional information added to each of the contents, and information related to Rating of each of the contents. These are pieces of information that are obtained by the link server 201 from the service server 202 corresponding to the Service-1, and may be pieces of information to which change, addition, deletion, or the like is carried out.

The database 503 is a database managed by the data managing unit 354 based on the data obtained from the service server 202 corresponding to the Service-2. The database 503 includes an ID for identifying each of the contents, a URL which is a reference of data of each of the contents, Note which is additional information added to each of the contents, Artist information related to each of the contents, and information related to a genre of each of the contents. These are pieces of information that are obtained by the link server 201 from the service server 202 corresponding to the Service-2, and may be pieces of information to which change, addition, deletion, or the like is carried out.

It is to be noted that the details of each the databases for each of the net services may be different or may be the same among the net services. The present invention can be implemented irrespective of the means and details of the management, as long as the link server 201 can provide the reproduction apparatus 101 with information related to the net service requested by the reproduction apparatus 101.

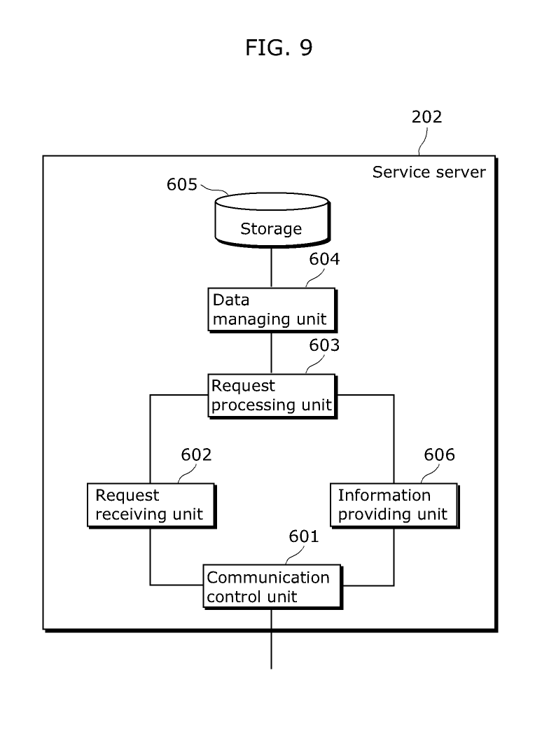

FIG. 9 is a diagram schematically illustrating an example of the internal configuration of the service server 202 according to Embodiment 1 of the present invention.

As illustrated in FIG. 9, the service server 202 includes: a communication control unit 601; a request receiving unit 602; a request processing unit 603; a data managing unit 604; a storage 605; and an information providing unit 606.

The communication control unit 601 performs control for connecting the service server 202 with a communication line connected to the outside such as the Internet. The communication control unit 601, upon receiving a request from outside to obtain data or to use a function, transmits the request to the request receiving unit 602. In addition, the communication control unit 601 transmits data to the outside based on an instruction from the information providing unit 606.

The request receiving unit 602 receives the request transmitted from the communication control unit 601 and transmits the request to the request processing unit 603 when the received request is a reasonable request. It is to be noted that, reasonability in this case is verified by determining, for example, whether or not the request which is received conforms to a specification of the net service, whether or not the requestor is an authorized device or user, and so on. In addition, as to the net service in which the verification of reasonability is not required, the request receiving unit 602 may transmit, to the request processing unit 603, the request transmitted from the communication control unit 601 as it is without verifying the reasonability.

The request processing unit 603 performs a process that meets the request, based on the request transmitted by the request receiving unit 602. In addition, the request processing unit 603 retrieves data from the data managing unit 604 as necessary, and transmits, as a result, the retrieved data, to the information providing unit 606.

As an example of the relationship between a request and a result, when the request is “obtainment of video data (identifier 0001)”, the request processing unit 603 requests obtainment of the video data having the identifier 0001 to the data managing unit 604 and transmits the obtained data to the information providing unit 606. When the request is “obtainment of a list of top 10 music of music data with high frequency of use”, the request processing unit 603 requests, to the data managing unit 604, obtainment of the list of top 10 music of music data with high frequency of use and transmits the list to the information providing unit 606.

The data managing unit 604 stores, into the storage 605, data transmitted by the request processing unit 603 and manages the data that is stored in the storage 605. Here, the management includes: holding a list of data stored in the storage 605, issuing an instruction of deleting or changing data to the storage 605, carrying out search based on the held list of data in response to a request from outside, and returning the result.

The storage 605 performs storage, deletion, change, and so on of data in response to an instruction from the data managing unit 604. The storage 605 can be implemented as long as being a medium capable of storing data, such as a hard disk, a non-volatile memory, and a volatile memory. In addition, the storage 605 does not have to be included in the service server 202 as long as the storage 605 can be used by the service server 202. The storage 605 may be an external storing device connected to the service server 202.

The information providing unit 606 transmits data transmitted by the request processing unit 603, to a requestor of the request received by the request receiving unit 602.

With the configuration described above, the service server 202 is capable of providing, to the outside, given data that meets a request from the outside, among pieces of data (video, music, management information related to the video and music, and the like) stored to be provided to the outside.

It is to be noted that the present invention can be implemented when the service server 202 is capable of sending a reply of some kind in response to a request from outside.

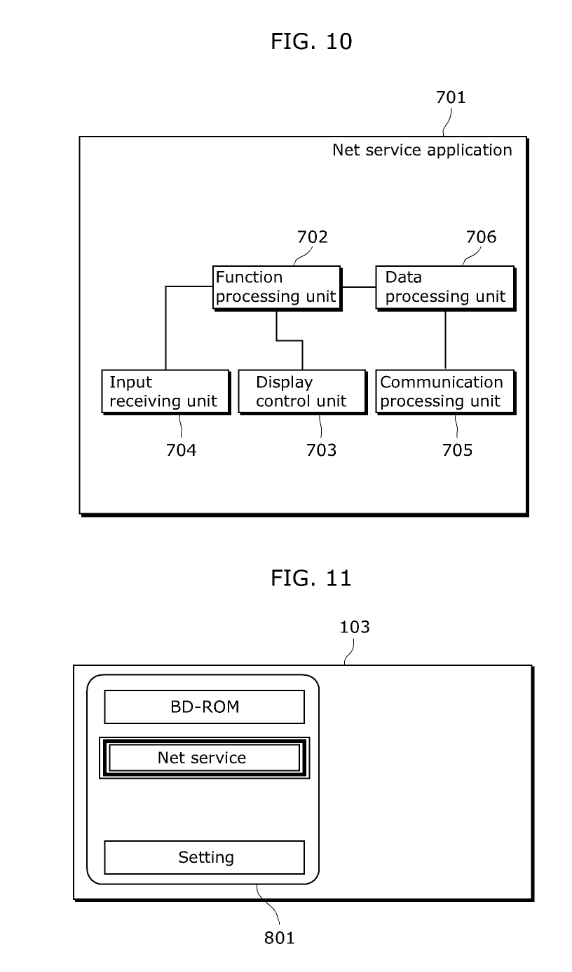

FIG. 10 is a diagram which schematically illustrates an example of the internal configuration of a program (net service application) executed by the application executing unit 301 included in the reproduction apparatus 101.

The net service application 701 includes: a function processing unit 702; a display control unit 703; an input receiving unit 704; a communication processing unit 705; and a data processing unit 706. The function processing unit 702 performs a series of processes necessary for the reproduction of a net service on the reproduction apparatus 101, performed by the net service application 701, and controls the display control unit 703, the input receiving unit 704, and the data processing unit 706 to implement the reproduction of the net service.

The display control unit 703 transmits, to the AV reproduction control unit 303 of the reproduction apparatus 101, details of display determined by the function processing unit 702, and eventually implements display on the display 103.

The input receiving unit 704, receives the details transmitted after received by the input receiving unit 305 of the reproduction apparatus 101, and transmits the received details to the function processing unit 702. In addition, when transmitting inputted details to the function processing unit 702, the input receiving unit 704 may integrate and eliminate the inputted details or sort out the inputted details. For example, the input receiving unit 704 is capable of, in response to a series of operations from the remote controller 102, transmitting an operation detail to the function processing unit 702, or ignoring an input that is not processed by the function processing unit 702.

The communication processing unit 705, according to a request from the data processing unit 706, establishes communication with the link server 201 or the service server 202, and controls transmitting and receiving of information to and from the link server 201 or the service server 202. In addition, such communication is implemented by the collaboration of the communication processing unit 705 and the communication control unit 304 of the reproduction apparatus 101.

The data processing unit 706 requests, to the communication processing unit 705, performing analysis of the details of the data obtained from the link server 201 and the service server 202. In addition, the data processing unit 706, according to a request from the function processing unit 702, provides data required by the function processing unit 702, using the result of the analysis. In addition, when the function processing unit 702 transmits certain information to the link server 201 or the service server 202, the data processing unit 706 converts the information received from the function processing unit 702 into a format that can be interpreted by the link server 201 or the service server 202 which are the destinations, and transmits the information resulting from the conversion to the destination via the processing unit 705.

Here, a net service application may support only a specified net service or may support plural net services. In addition, in the case where a single net service application uses plural link servers 201, or uses only one link servers 201 but the format of data received from the link server 201 is different according to a net service to be reproduced, it is possible for even one net service application to use plural data formats, by providing the data processing unit 706 for each of the data formats.

FIG. 11 is a diagram illustrating an example of the display of the display 103 according to Embodiment 1 of the present invention. The display 103 as illustrated in the diagram displays a GUI (Graphical User Interface) 801 for allowing a user to select an operation to be performed next by the reproduction apparatus 101, such as changing a type, settings, and the like of the content to be reproduced by the reproduction apparatus 101. The user can select a desired operation to be performed next, by operation performed on the remote controller 102.

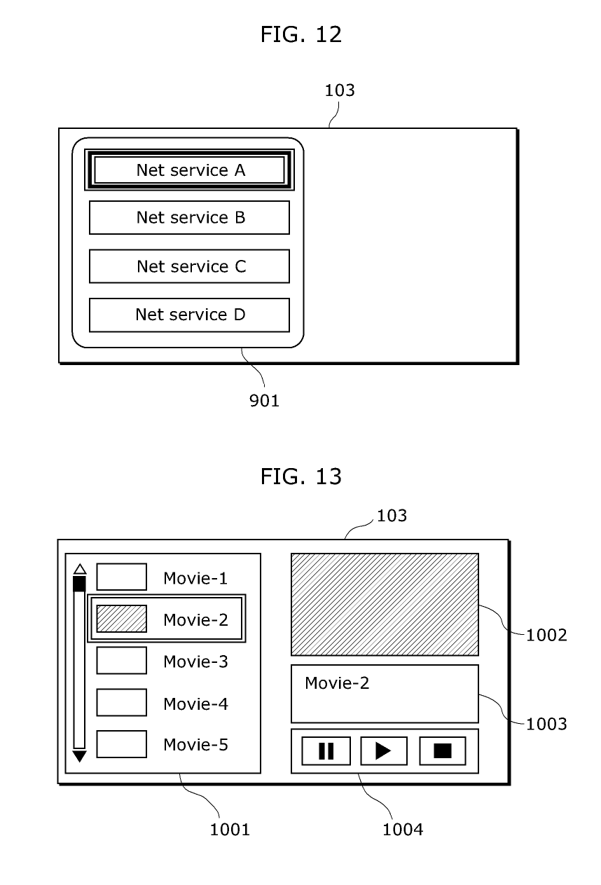

FIG. 12 is a diagram which illustrates an example of the display on the display 103 after the user selected the “net service” in FIG. 11. The display 103 illustrated in the diagram displays a GUI 901 for allowing a user to select which of the net services to be reproduced when the reproduction apparatus 101 corresponds to plural net services. It is to be noted that display of the GUI 901, input receiving processing from the user, and the like may be performed by the net service application and may be performed by a different program incorporated in the reproduction apparatus 101.

FIG. 13 is a diagram which illustrates an example of the display on the display 103 after the user selected a given net service in FIG. 12. The example displayed here represents the case where a net service that provides plural items of video are provided is reproduced. In addition, the display 103 displays: a GUI 1001 for allowing a user to select, from a list of items of provided video, a desired item of video to be reproduced; an image 1002 that is a result of reproducing the selected item of video; a GUI 1003 displaying information attached to the selected item of video; and a GUI 1004 for controlling, by the user, the reproduction state for the reproduction of the select video. The net service application receives an input from the user performed on the remote controller 102 and performs a variety of processes according to the operation details. For example, the net service application, scrolls the list displayed on the GUI 1001 when an up button or a down button on the remote controller 102 is pressed, and issues, to the AV reproduction control unit 303 of the reproduction apparatus 101, an instruction of reproducing the content selected on the list of the GUI 1001 when a confirmation button on the remote controller 102 is pressed. The AV reproduction control unit 303 uses the communication control unit 304 to receive video data from the service server 202, reproduces the received video data, and displays the reproduced video data on the display 103. It is to be noted that the method of reproducing video data and still image data can be implemented using known techniques, and thus a detailed explanation for them will be omitted.

Here, the procedures from activating a net service application in the CE device to displaying an initial screen of the net service by the net service application will be described.

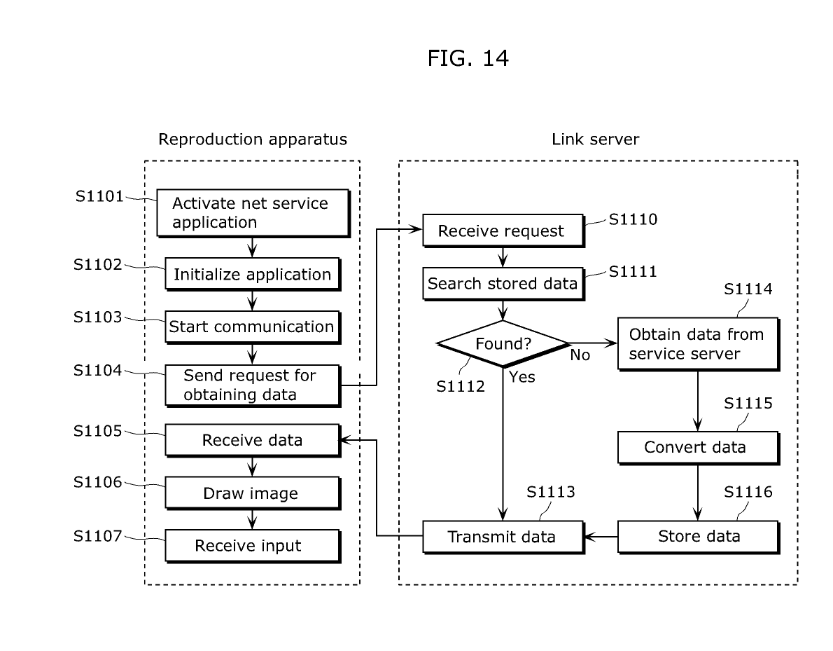

FIG. 14 is a flowchart illustrating processes performed when a user selects a given net service in the GUI 901 illustrated in FIG. 12. More specifically, FIG. 14 shows the case where, after a net service application capable of reproducing the net service is activated, the net service application obtains a list of items of video or additional information from the link server 201 and obtains video data to be reproduced from the service server 202.

First, the CE device activates a net service application (S1101). Next, the activated net service application initializes the inside of the net service application (S1102). This initialization process includes, in addition to an initialization process performed by a commonly-used program, setting and the like necessary for the net service to connect to the link server 201 and the service server 202. Next, the net service application connects to the link server 201 (S1103) and sends a request for obtaining a list of items of reproducible video and additional information, to the link server 201 (S1104).

The link server 201, upon receiving the request from the net service application (S1110), searches corresponding information in data stored in the link server 201 (S1111). In addition, the link server 201 determines whether or not the corresponding information is found (S1112), and transmits the corresponding information as a reply to the net service application when the corresponding information is found (S1113). In the case where the corresponding information is not found in the data stored in the link server 201, the link server 201 sends, to the corresponding service server 202, a request for obtaining information required by the net service application, based on the information which is related to the net service and which is included in the request of the net service application, and obtains data (S1114). The link server 201 converts the data obtained from the service server 202 into a format that can be used by the net service application (S1115), adds the result of the conversion as necessary to the stored data in the link server 201 (S1116), and transmits the result of the conversion to the net service application (S1113).

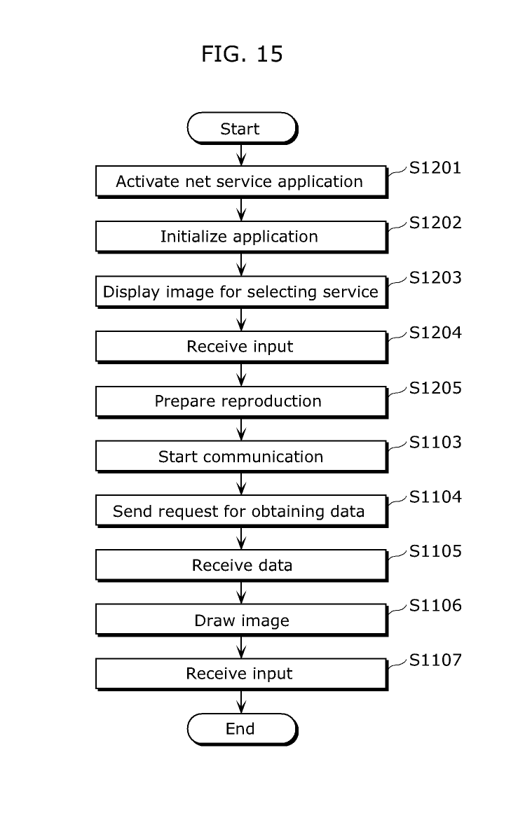

The net service application, upon receiving the data from the link server 201, analyzes the details of the received data (S1105), requests the AV reproduction control unit 303 to display an image such as the image illustrated in FIG. 13 (S1106), and then comes into the state for receiving an operation by a user as necessary (S1107). FIG. 15 is a flowchart illustrating processes from selecting a net service to reproducing data in the selected net service in the case where the net service application corresponds to plural net services.

It is to be noted that processes identical to the processes in the flowchart illustrated in FIG. 14 are provided with the same numerical references and description for them will be omitted. In addition, in the processes illustrated in FIG. 15, for example, the GUI 901 illustrated in FIG. 12 indicates plural net services corresponding to the net service application and the display of the GUI 901 is also a result of an instruction from the net service application.

First, the CE device activates a net service application (S1201). Next, the activated net service application initializes the inside of the net service application (S1202). Next, the net service application sends an instruction, to the AV reproduction control unit 303 of the reproduction apparatus 101, to display a net service selection image such as the GUI 901 illustrated in FIG. 12, in order to allow the user to select a desired net service to be reproduced (S1203), and receives an input from the user (S1204). In response to the selecting, by the user, of a desired net service to be reproduced, the net service application prepares for reproduction corresponding to the selected net service (S1205), and connects to the link server 201 (S1103). It is to be noted that processes from S1103 onward are identical to the processes in the flowchart illustrated in FIG. 14, and thus the same numerical references are provided and the description for them will be omitted. In addition, since the processes performed by the link server 201 illustrated in FIG. 14 are the same as well, the description for the process procedure performed by the link server 201 is omitted in FIG. 15.

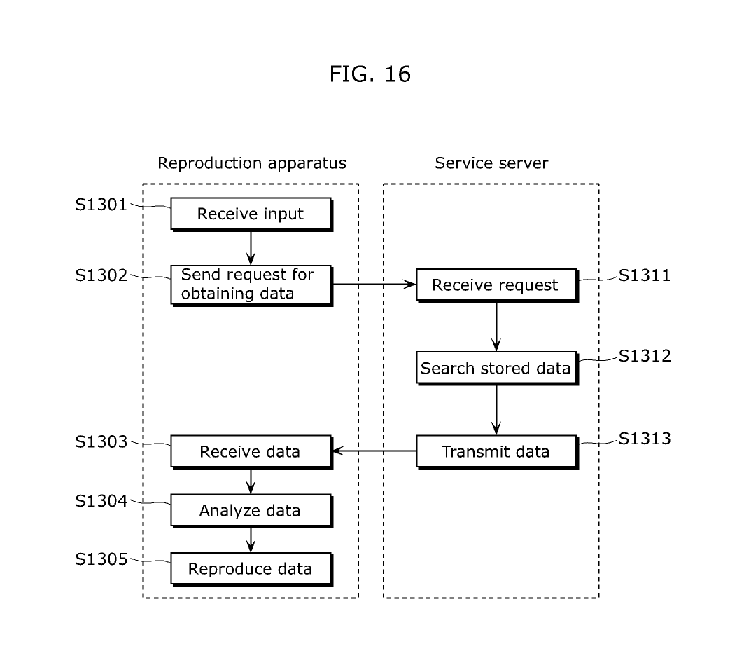

FIG. 16 is a flowchart related to processes for obtaining, from the service server 202, a content (video) which the user desires to reproduce when the display 103 displays the image illustrated in FIG. 13, and reproduces the content in the reproduction apparatus 101.

The net service application, upon identifying that a user selects a specified content (S1301), sends a request for obtaining data of the selected content, to the service server 202 corresponding to the net service that is currently reproduced (S1302).

The service server 202, upon receiving the request for obtaining data from the reproduction apparatus 101 (S1311), searches data that matches the requested details among the content data stored in the service server 202 (S1312), and transmits the result to the reproduction apparatus 101 (S1313).

The reproduction apparatus 101, upon receiving, from the service server 202, a result corresponding to the request transmitted in S1302 (S1303), analyzes the details of the received data (S1304), and reproduces the data (S1305).ₛ

It is to be noted that, when corresponding data is not found in the searching performed in S1312, the information transmitted in S1313 may be a message indicating nondetection, so that the reproduction apparatus 101 recognizes, in S1304, that the data requested is not found, and the nondetection message may be displayed on the display 103 in the reproduction in S1305.

It is to be noted that, since video data is generally large in data size, when a net service stores (also referred to as duplicates, or cashes) all of the stored video data into the link server 201, the link server 201 needs to prepare a storage having a large capacity. For this reason, there are many cases where video data is stored not in its entirety into the link server 201. Likewise, there is the case where a large data size leads to an increase in a communication load due to routing through the link server 201 in the communication path. In view of the above, the flowchart in FIG. 16 illustrates, as an example, the case where the reproduction apparatus 101 obtains video data directly from the service server 202. However, since such data as photographs, music, and the like are small in size compared to video data, it is possible to store such data in the link server 201 or obtain such data through the link server 201.

When obtaining data stored in the link server 201, it is possible to implement an embodiment of the present invention by replacing the processes (S1311, S1312, and S1313) to be performed by the service server 202 with the processes to be performed by the link server 201, in the process procedure in FIG. 16.

It has been described that the AV reproduction control unit 303 illustrated in FIG. 3 receives an instruction issued by the net service application, such as graphics drawing and video reproduction, and creates an image to be displayed on the display 103, based on the details of the instruction, and now more detailed processes will be described.

The AV reproduction control unit 303 has, for example, a function of decoding image data and displaying a result of decoding, a function of drawing a specified string, and function of drawing a rectangle, as functions for graphics drawing.

In addition, the AV reproduction control unit 303 decodes and displays video data and music data as functions for reproducing AV data.

In addition, data to be a target for reproduction such as AV data and image data is data stored in the reproduction apparatus 101, data transmitted by the net service application, or data obtained from the link server 201 or the service server 202 using the communication control unit 304.

For the method of obtaining AV data using the communication control unit 304 performed by the AV reproduction control unit 303, known techniques such as HTTP (Hyper Text Transfer Protocol), RTP (Real-time Transport Protocol), and RTSP (Real Time Streaming Protocol) may be used, or a unique protocol defined by the service server 202 or the link server 201 may be used with use of TCP/IP (Transmission Control Protocol/Internet Protocol).

It is to be noted that an embodiment of the present invention can be implemented irrespective of the types of obtaining method, as long as the reproduction apparatus 101 (net service application or the AV reproduction control unit 303) can obtain AV data from the service server 202 or the link server 201.

In addition, if a process related to copyright protection is necessary when reproducing AV data, the AV reproduction control unit 303 may have a function related to copyright protection. To be specific, all of the processes can be performed by the AV reproduction control unit 303 when copyright protection can be removed using only the obtained AV data. On the other hand, when it is necessary to use information other than the AV data, for example, data that needs to be obtained from the service server, the net service application obtains necessary data (hereinafter referred to as authentication data) from the service server 202 or the link server 201. The net service application sends a reproduction instruction and transmits the authentication data to the AV reproduction control unit 303. This allows the AV reproduction control unit 303 to reproduce the AV data including the process of copyright protection. In general, the presence or absence of the copyright protection and details of a process are different for each of the net services. It is therefore assumed that the net service application knows, in advance, what kind of processes is required by each of the net services. As the method for knowing in advance, a process may be included in the program of the net service application in advance, or a processing method may be obtained from the link server 201. An embodiment of the present invention can be implemented irrespective of the method, as long as the processing method is known before reproducing AV data.

It is to be noted that obtainment of AV data and reproduction of the obtained AV data can be performed in parallel. More specifically, it is possible to start reproducing the obtained AV data during the process of obtaining the AV data.

The net service provides not only data such as video and music but also a variety of functions in some cases. For example, it is possible to search data using a keyword and provide a list of search results, to register on the net service, data generated by a user himself in the net service, and to post a comment by the user on the data provided by the net service.

When using these functions, the net service application may directly communicate with the service server 202 to use the provided function, or may use the function of the service server 202 via the link server 201.

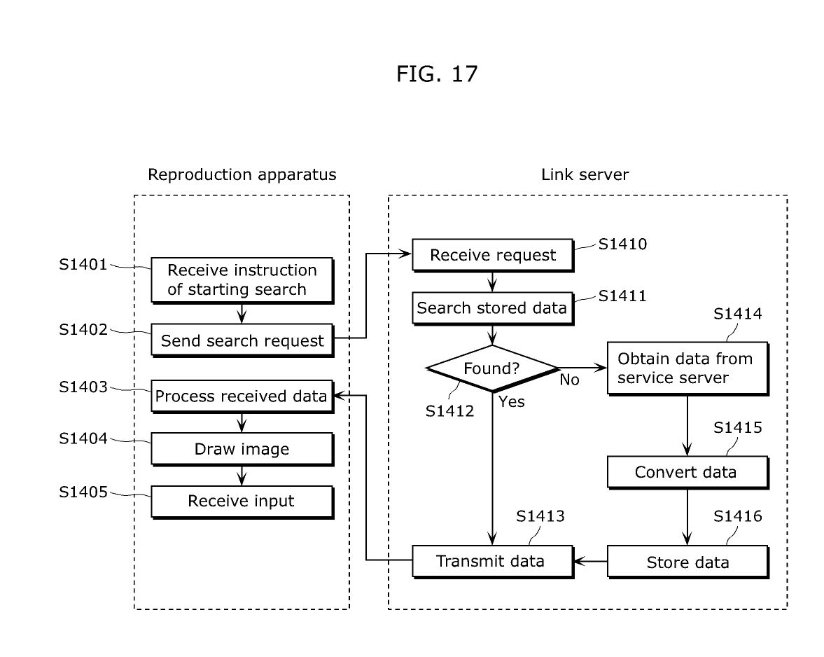

FIG. 17 is a flowchart illustrating processes when the net service application uses, as a function provided by the service server 202, video search using, for example, a keyword, via a video searching function provided by the link server 201.

First, the net service application receives, from a user, an instruction of starting a search, through inputting of a keyword or selecting of a search menu by the user, or the like (S1401). Next, the net service application uses the communication control unit 304 to send a search request to the link server 201, with use of a format that can be received by the link server 201 (S1402). The link server 201, upon receiving the request from the net service application (S1410), searches corresponding information from among data stored in the link server 201 (S1411). The link server 201 determines whether or not the corresponding information is found (S1412), and transmits the corresponding information as a reply to the net service application when the corresponding information is found (S1413). In the case where the corresponding information is not found in the data stored in the link server, the link server 201 sends, to the corresponding service server 202, a request for obtaining information required by the net service application, based on the information related to the net service included in the request of the net service application, and obtains data (S1414). The link server 201 converts the data obtained from the service server 202 into a format that can be used by the net service application (S1415), adds the result of the conversion as necessary to the stored data in the link server 201 (S1416), and transmits the result of the conversion to the net service application (S1413).

The service application, upon receiving the data from the link server 201, analyzes the details of the received data (S1403), and requests the AV reproduction control unit 303 to display an image such as the image illustrated in FIG. 13 (S1404). In this case, the GUI 1001 illustrated in FIG. 13, for example, represents the search result based on the keyword inputted first by the user. Then the net service application comes into the state for receiving an operation from the user as necessary (S1405).

It has been described above that the net service application sends a request to the link server 201, using the communication control unit 304. However, when the net service application can directly use the search function provided by the service server 202, the net service application can directly request the service server 202 without routing through the link server 201, receive a result from the service server 202, and analyze the details of the result to present to the user. In addition, to which one of the link server 201 and the service server 202 the request should be sent depends on the function held by the net service application. To be specific, in the case where the net service application knows specifications related to a request, such as a communication method for a search request, a format of the request, details of the request, a format of a response, and details of the response and processes for satisfying the specifications are held by the net service application, it is possible to directly issue a request to the service server 202.

However, when a given net service application corresponds to plural net services, the number of functions which should be held by the net service application increases as the number of the corresponding net services increases. Thus, the link server 201 performs the processes that depend on the specifications related to a variety of different requests to the net services. The link server 201 receives a request based on a certain restricted specification from the net service application, and converts the request from the net service application into a request depending on each of the net services. This allows the net service application to issue a request indirectly to each of the net services, by issuing a request simply to the link server 201 without noticing the difference of the specification between the net services. It is to be noted that the information attached to a search request is, for example, information identifying a net service, information related to a search method, and information that specifies a maximum value of the number of items of a search result. As the information related to a search method, it is possible to specify, for example, a keyword inputted by a user, “most recently registered”, “most viewed”, and so on. It is to be noted that an embodiment of the present invention can be implemented irrespective of the details of the information attached to a search request, as long as the information attached to a search request can be received and searched by the service server 202 or the link server 201.

An example of processes in the case where a search function is used has been described; however, the function is not limited and other functions can be implemented according to an embodiment of the present invention. Other function is, for example, posting a comment, data registration, user authentication, a variety of settings of a net service, and so on.

It is to be noted that, when the net service application knows, in advance, the method of requesting to the net service, the method of analyzing data obtained according to the request, and the like, the net service application can reproduce a net service by directly communicating with the service server 202 without routing through the link server 201, at the time of trying reproduction of the net service. In particular, when the information provided by the net service is restrictive, for example, when the information is specialized in the weather forecast and stock price information, routing through the link server 201 provides little benefit due to an increase in process procedure and complication of the communication path resulting from going through the link server 201. Accordingly, it is effective to directly communicate with the service server 202 in such cases.

It is to be noted that, when an application is provided in a format independent of the architecture of: a CPU mounted in the CE device, such as the Java Virtual Machine, the Flash player, or the like; an OS; or the like, the application is operable on plural different CE devices without requiring modification.

It is to be noted that an application may be prepared for each of the net services, or a single application may correspond to plural net services. The present invention can be implemented when a given application corresponds to at least one net service.

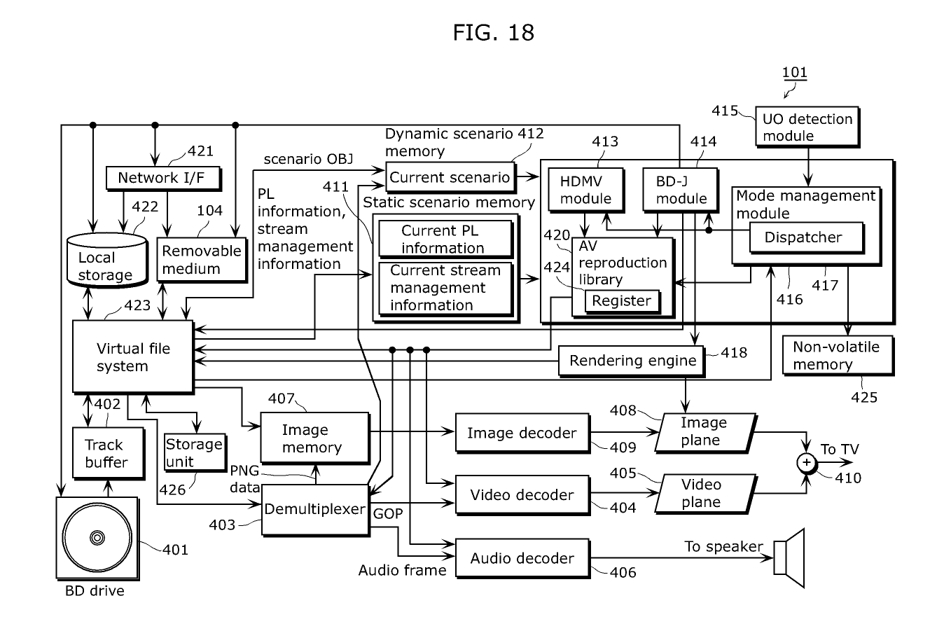

FIG. 18 is a block diagram which roughly shows a functional configuration of a BD-ROM reproduction apparatus capable of implementing Embodiment 1. The reproduction apparatus 101 in the diagram includes: a BD-ROM drive 401; a track buffer 402; a demultiplexer 403; a video decoder 404; a video plane 405; an audio decoder 406; an image memory 407; an image plane 408; an image decoder 409; an adder 410; a static scenario memory 411; a dynamic scenario memory 412; an HDMV (High Definition Movie) module 413; a BD-J (Blu-ray Disc Java) module 414; a UO (User Operation) detection module 415; a mode management module 416; a dispatcher 417; a rendering engine 418; an AV reproduction library 420; a network interface 421; a local storage 422; a virtual file system 423; a register 424; a non-volatile memory 425; and a storage unit 426.

The BD-ROM drive 401 loads/ejects a BD-ROM (an example of the recording medium 105) and executes an access to the BD-ROM. It is to be noted that the BD-ROM drive 402 may be capable of not only reading a BD-ROM but also reading of and writing to a BD-RE that can be read from and written to, and may further be capable of using a variety of types of recording medium such as a DVD and a CD.

The track buffer 401 is a FIFO (First In First Out) memory. An access unit read from the BD-ROM is stored in the track buffer 402 in a first-in first-out system.

The demultiplexer 403 performs multiple separation on a transport stream stored in the BD-ROM that is loaded by the BD-ROM drive 401, the local storage 422, or the removable medium 104. Then the demultiplexer 403 obtains a video frame and an audio frame configuring a GOP (Group of Pictures), outputs the video frame to the video decoder 404, and outputs the audio frame to the audio decoder 406. In addition, the demultiplexer 403 stores a sub video stream into the image memory 407, and stores navigation button information into the dynamic scenario memory 412. In addition, the multiple separation processing performed by the demultiplexer 403 includes a conversion process for converting a TS packet to a PES (packetized Elementary Stream) packet.

The video decoder 404 decodes the video frame outputted from the demultiplexer 403 and writes, into the video plane 405, a picture in an incompressible form.

The video plane 405 is a memory for storing a picture in the incompressible form.

The audio decoder 406 decodes the audio frame outputted from the demultiplexer 403 and outputs audio data in the incompressible form. The image memory 407 is a buffer for storing: the sub video stream read from the demultiplexer 403; the PNG (Portable Network Graphics) data in the navigation button information; or the image file read from the BD-ROM, the removable medium 104, or the local storage 422 via the virtual file system 423.

The image plane 408 is a memory which has a region for a singe screen, and in which the sub video stream that has been decompressed, the PNG data, the image file, and so on are disposed. The image decoder 409 decompresses the sub video stream, the PNG data, the image file, and the like which are stored in the image memory 407 and writes them into the image plane 408. A variety of menus and the sub video appear on the screen by decoding the sub video stream.

The adder 410 combines and outputs the picture data in the incompressible form stored in the video plane 405 and an image decompressed on the image plane 408.

The static scenario memory 411 is a memory for storing a current playlist (current PlayList) or current stream management information. The current PlayList (occasionally abbreviated to current PL) is a playlist that is currently a processing target among plural playlists recorded on the BD-ROM, the local storage 422, or the removable medium 104. The current stream management information refers to the stream management information that currently is a processing target among plural items of stream management information recorded on the BD-ROM, the local storage 422, or the removable medium 104.

The dynamic scenario memory 412 is a memory in which a current dynamic scenario is stored and which is to be used for the processes performed by the HDMV module 413 and the BD-J module 414. The current dynamic scenario is a scenario that is currently a target for execution among plural scenarios recorded on the BD-ROM, the local storage 422, or the removable medium 104.

The HDMV module 413 is a DVD virtual player that is a main body to execute the HDMV mode, and executes the current scenario program read by the dynamic scenario memory 412.

The BD-J module 414 is a Java platform and includes a Java Virtual Machine, a configuration, and a profile. The BD-J module 414 generates a current Java object from a Java class file read by the dynamic scenario memory 412, and executes the generated Java object. The Java Virtual Machine converts the Java object written in the Java language into a native code of a CPU (Central Processing Unit) included in the reproduction apparatus 101, and causes the CPU to execute the native code resulting from the conversion.

The UO detection module 415 detects an operation of a user performed on a remote controller or a front panel (an operation panel such as a touch-pad) of the reproduction apparatus 101, and outputs, to the mode management module 416, information (hereinafter referred to as UO) indicating the operation of the user.

The mode management module 416 holds a mode management table read from the BD-ROM, the local storage 422, or the removable medium 104, and performs mode management and branching control. The mode management performed by the mode management module 416 includes: module allocation for determining whether the dynamic scenario is executed by the HDMV module 413 or by the BD-J module 414, reproduction instruction to an allocated module, and monitoring reproduction state of the allocated module. Monitoring the reproduction state makes it possible that, when shifting to another title in such a case as an end of reproduction of a title performed by the HDMV module 413 or the BD-J module 414, the mode management module 416 selects a title to be reproduced next, allocates a module suitable to the selected title, and issues a reproduction instruction to the allocated module, so as to continue the reproduction.

In addition, the mode management module 416 may obtain the details of the register 424 from the AV reproduction library 420 during reproducing a title, and store a part or all of the details into the non-volatile memory 425 together with other information that can be obtained by the mode management module 416. Furthermore, the mode management module 416, when issuing a reproduction instruction to the allocated module in the mode management, may issue the instruction together with the details obtained from the non-volatile memory 425 so as to start reproduction in the state different from a normal initial state. In addition, the mode management module 416 may issue an instruction of generating data to the virtual file system 423. The details will be described later.

The dispatcher 417 selects, from among the UOs, only a suitable UO to the current mode of the reproduction apparatus 101, and transmits the selected UO to the module executing the mode. For example, the dispatcher 417, when receiving a UO such as up, down, left and right, activate, and so on during the execution of the HDMV mode, outputs these UOs to the module in the HDMV mode.

The rendering engine 418 includes an infrastructure software such as the Java 2D, OPEN-GL (Open Graphics Library), and so on. The rendering engine 418 performs drawing of computer graphics according to an instruction from the BD-J module 414, and outputs the drawn computer graphics to the image plane 408.

The AV reproduction library 420 executes the AV reproduction function and the playlist reproduction function in response to a function call from the HDMV module 413 or the BD-J module 414. The AV reproduction function is a group of functions which follow the functions of DVD players or CD players, performs the processes such as starting reproduction, stopping reproduction, pause, unpause, cancelling of the still image function, fast-forward of which a reproduction speed is specified by an immediate, rewind of which a reproduction speed is specified by an immediate, switching of audio, switching of sub video, switching of angle, and so on. The playlist reproduction function is a function for performing the starting reproduction and the stopping reproduction according to the playlist information, among the functions of the above-described AV reproduction function.

In addition, the AV reproduction library 420 includes the register 424. The register 424 is capable of storing reproduction state of the playlist, arbitrary information used by the content, and so on. The reproduction state of the play list indicates which AV data is used among a variety of AV data information items described in the play list, which position (time) of the playlist is being reproduced, and the like. When the reproduction state of the playlist changes, the AV reproduction library 420 stores, in the register 424, the details of the reproduction state of the playlist. In addition, the AV reproduction library 420, in response to an instruction from a content executed by the HDMV module 413 or the BD-J module 414, stores a value specified by the content or transmits the stored value to the content. The network interface 421 is an interface for performing communication with the outside of the reproduction apparatus 101, and accesses to an accessible server via the Internet or accesses to a server connected via a local network. For example, the network interface 421 downloads a BD-ROM additional content that is available on the Internet, or transmits and receives data to and from a server on the Internet specified by the content, thereby enabling reproduction of the content using the network function. The BD-ROM additional content is a content not included in an original BD-ROM, such as an additional sub audio, subtitles, bonus clips, application, and so on. In addition, since the network interface 421 can be controlled by the BD-J module 414, it is possible to download the additional content available on the Internet into the local storage 422 or the removable medium 104.

The local storage 422 and the removable medium 104 are used for storing additional content that has been downloaded and data used by the application. The region for storing additional content is separated for each BD-ROM. In addition, the region that the application can use for holding data is separated for each application. In addition, merge management information in which a merge rule that specifies how to merge the downloaded additional content to the data on the BD-ROM is stored in the local storage 422 or the removable medium 104.

The virtual file system 423 constructs a virtual BD-ROM (virtual package) in which an additional content stored in the local storage 422 or the removable medium 104 and the content on the BD-ROM are merged, based on the merge management information downloaded onto the local storage 422 or the removable medium 104 together with the additional content. The HDMV module 413 or the BD-J module 414 is capable of referring to the virtual package and the original BD-ROM without distinction. During the reproduction of the virtual package, the reproduction apparatus 101 performs reproduction control using not only the data on the BD-ROM but also the data on the local storage 422, the removable medium 104, and the storage unit 426.

The non-volatile memory 425 is a recording medium that can be read and written to, and a medium capable of holding recorded data even when power is not supplied. The non-volatile memory 425 is, for example, a flash memory, FeRAM (Ferroelectric Random Access Memory), and the like. In addition, recording medium that can be written to by the removable medium 104, the local storage 422, or the BD-ROM drive 401 may be used as the non-volatile memory 425. In addition, a medium accessible via the network interface 421 may be used as the non-volatile memory 425 as long as the medium can hold recorded data independent of a power-supply condition of the reproduction apparatus 101.

The storage unit 426 is a recording medium capable of storing arbitrary data. The virtual file system 423 is capable of storing specified data into the storage unit 426, in response to an instruction from the mode management module 416.

The above-described constituent elements represent an example of the reproduction apparatus 101 of the BD-ROM capable of reproducing the net service. Here, it is also possible to implement the net service application as a BD-J title.

In this case, for example, part of the BD-J module 414 and the mode management module 416 corresponds to the application executing unit 301, part of the BD-J module 414 corresponds to the application control unit 302, the UO detection module 415 and the dispatcher 417 correspond to the input receiving unit 305, the AV reproduction library 420, the image memory 407, the image decoder 409, the video decoder 404, the audio decoder 406, the image plane 408, the video plane 405, and the rendering engine 418 correspond to the AV reproduction control unit 303, the network I/F 421 corresponds to the communication control unit 304, the non-volatile memory 425 corresponds to the storage unit 2201, and the local storage 422 and the removable medium 104 correspond to a data storage 2301.

It is to be noted that, when the operations described in this embodiment can be implemented, it is possible to implement an embodiment of the present invention with another functional configuration.

It is to be noted that an organization that provides a net service (hereinafter referred to as a net service company) is generally different from an organization that manufactures a reproduction apparatus (hereinafter referred to as a manufacturing company). With this configuration, it is possible that yet another different organization (hereinafter referred to as a link server company) provides a link server and carries out development and maintenance of a net service application In this case, when the net service company mainly provides services for PCs, it is too much costly for the net service company to support for each of the reproduction apparatuses which are different for each manufacturing company, due to an increase in the number of the reproduction apparatuses for supporting the services, even if an increase in earnings resulting from an increase in the number of users can be expected. On the other hand, as described in Technical Problem, considerable costs are required for the manufacturing companies in order to follow the net services which continue to increase and decrease in number and increase the individual functions as well. Under such a circumstance, a user cannot widely reproduce net services on the CE device. In view of the above, the link server company integrates, only to the link server, the follow-up to the net services which continue to increase and decrease in number and increase the individual functions as well Then the link server company performs development and maintenance of the net service application that is executed in collaboration with the link server. In addition, the environment of the reproduction apparatus necessary for executing the net service application is integrated by some form, thereby eliminating the necessity for the net service company to individually support the reproduction apparatuses. In addition, since it is only necessary to prepare the environment for the net service application to operate, it is possible for the manufacturing companies to significantly reduce the costs. In addition, it is possible for the link server company to gain an income from the expenses that match the costs reduced by the net service company and the manufacturing company, further from an advertising revenue resulting from posting an advertisement on the net service application, and so on. The above-described mechanisms allow establishing a business model which makes it possible that a user can reproduce a large number of net services on the CE device while the net service company, the manufacturing company, and the link server company mutually make a profit.

### Embodiment 2

In Embodiment 1, in the case where a reproduction apparatus is incapable of reproducing a content when a net service application instructs reproduction of the content that is selected by a user, there is a problem that the selected content cannot be reproduced in spite of the fact that the user has selected the content, which leads to providing an unpleasant feeling to the user.

In Embodiment 2 according to the present invention, a method is described which reduces unpleasant feeling to be provided to the user, by including, in the reproduction apparatus, a reproduction error notification unit which, when reproduction of a specified content fails, notifies the net service application of the failure of reproduction.

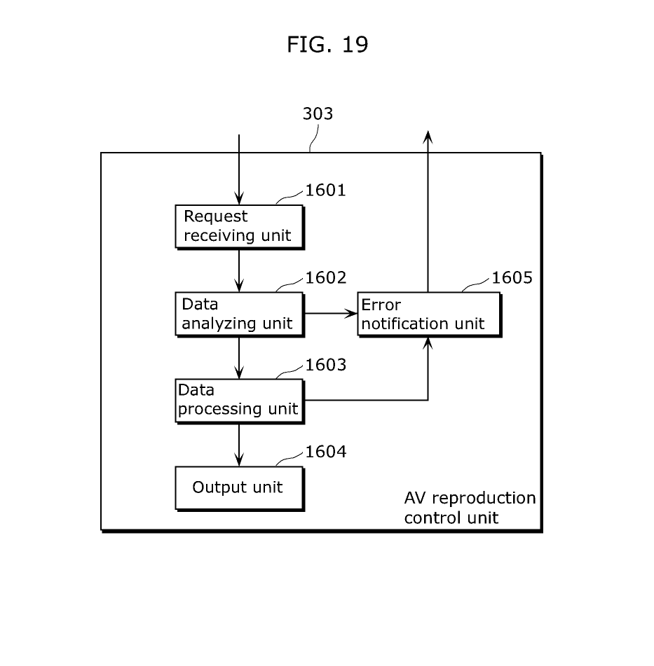

FIG. 19 is a diagram which illustrates an internal configuration of the AV reproduction control unit 303 illustrated in FIG. 3, according to Embodiment 2.

The AV reproduction control unit 303 includes: a request receiving unit 1601; a data analyzing unit 1602; a data processing unit 1603; an output unit 1604; and an error notification unit 1605.

The request receiving unit 1601 receives a request from the display control unit 703 included in the net service application 701 illustrated in FIG. 10, and transmits the details of the request to the data analyzing unit 1602 when the details of the received request are reasonable. In addition, the request receiving unit 1601 returns an error to the display control unit 703 when the details of the received request are not reasonable.

The data analyzing unit 1602 analyzes the details of data to be reproduced and determines whether or not there is an error. For example, the data analyzing unit 1602 interprets the details of data to be reproduced and determines whether or not the data can be displayed, based on management information attached to image data or part of the image data. In addition, when the request from the net service application 701 includes reference information of data that can be obtained from the outside of the reproduction apparatus 101 via the communication control unit 304 instead of to-be-reproduced data itself, the data analyzing unit 1602 is capable of performing the above-described determination while obtaining data from a reference source using the communication control unit 304. When it is determined, in the determination performed by the data analyzing unit 1602, that the data cannot be displayed, the data analyzing unit 1602 notifies a result of the determination to the error notification unit 1605.

The data processing unit 1603 retrieves the details of data to be actually displayed, from the data which is determined by the analyzing unit 1602 as can be displayed, and transmits the retrieved details to the output unit 1604. For example, this process is a process generally called as decoding. It is to be noted that the process of retrieving the details of data to be reproduced and transmitting the retrieved details to the output unit 1604 performed by the data processing unit 1603 is not necessarily carried out after the whole details of data are retrieved. More specifically, the data processing unit 1603 may transmit to the output unit 1604, upon retrieving part of the details of data to be reproduced, the part of the details of data, and retrieve the remaining portion of the details of data on a parallel with the transmitting. As described above, it is also possible to perform the processing of the data processing unit 1603 on a parallel with the processing of the output unit 1604.

In addition, the data processing unit 1603, when the retrieval of details to be displayed is failed due to some cause, notifies the error notification unit 1605 of the failure. Here, some cause is, for example, corruption or missing of data, or cause resulting from an error in part of constituent elements of the reproduction apparatus 101. In addition, the data processing unit 1603 is also capable of starting transmission to the output unit 1604, after attempting retrieval of a part or all of data to be reproduced and then confirming that there is no error before performing the transmission to the output unit 1604. With this, it is possible to avoid the case where reproduction of to-be-reproduced data succeeds only halfway. In addition, it is possible to implement more optimal output, by performing setting of the output unit 1604 according to the details of data to be reproduced. It is to be noted that the data processing unit 1603 is capable of notifying the error notification unit 1605 also in the case where an error is detected when attempting retrieval of the whole data or a part or all of the data to be reproduced before performing the transmission to the output unit 1604.

When the details of data to be displayed which is retrieved by the data processing unit 1603 is a video signal, the output unit 1604 performs a process for displaying the video signal on the display 103. When the details of data to be displayed which is retrieved by the data processing unit 1603 is an audio signal, the output unit 1604 outputs the audio signal to the speaker. For example, when the reproduction apparatus 101 is separate from the display 103, the output unit 1604 performs transmission of an output signal from an HDMI terminal, a Composite terminal, or the like.

The error notification unit 1605 receives a notification from the data analyzing unit 1602 or the data processing unit 1603 and notifies the net service application of the details of the notification.

It is to be noted that, although the notification in the case of occurrence of error is described here, substantially the same mechanism may be used in a successful case as well. The configuration described above allows the net service application to clearly determine whether the request for reproduction succeeded or failed.

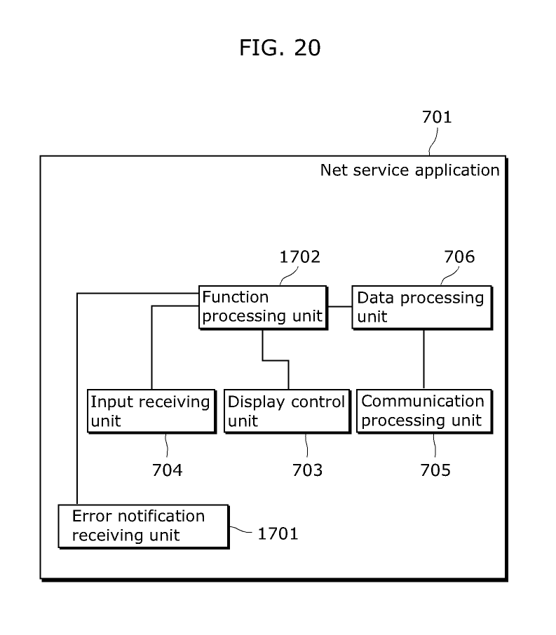

FIG. 20 is a diagram illustrating an internal configuration of a net service application 701 according to Embodiment 2 of the present invention. It is to be noted that constituent elements identical to constituent elements in FIG. 10 are provided with the same numerical references and description for them will be omitted.

An error notification receiving unit 1701 receives a notification from the error notification unit 1605 illustrated in FIG. 19, and transmits the details of the notification to the function processing unit 1702.

The function processing unit 1702 is capable of performing a process based on the details transmitted by the notification receiving unit 1701, in addition to the processes performed by the function processing unit 702 illustrated in FIG. 10. To be specific, the function processing unit 1702, in order to notify a user of occurrence of an error in reproduction, presents information indicating the occurrence of the error, on the display 103, using the display control unit 703. In addition, the function processing unit 1702 is capable of deleting the content from a list of contents as illustrated as the GUI 1001 in FIG. 13 so as to prevent the user from selecting the same content subsequent to the error, or ignoring even when the content is selected. In addition, the function processing unit 1702 is also capable of notifying the link server 201 or the service server 202 of the fact that reproduction fails, using the data processing unit 706. This allows the link server 201 or the service server 202 to avoid transmitting information related to the content having an error in response to a request from the reproduction apparatus 101 subsequent to the error, or to include, in the information attached to the content, information indicating that an error occurred in the past. This allows the net service application to know there is a possibility of occurrence of an error prior to reproduction, even when the information related to the content is obtained from the link server 201 or the service server 202.

### Embodiment 3

In Embodiment 1 and Embodiment 2, in the case where a reproduction apparatus is incapable of reproducing a content when a net service application instructs reproduction of the content that is selected by a user, there is a problem that the selected content cannot be reproduced in spite of the fact that the user has selected the content, which leads to providing an unpleasant feeling to the user.

In Embodiment 3 according to the present invention, a method is described which reduces unpleasant feeling to be provided to the user, by including: in an application, a type determining unit which determines a type of a content to be reproduced; and a terminal performance information providing unit which provides the application with information related to the type of a reproducible content.

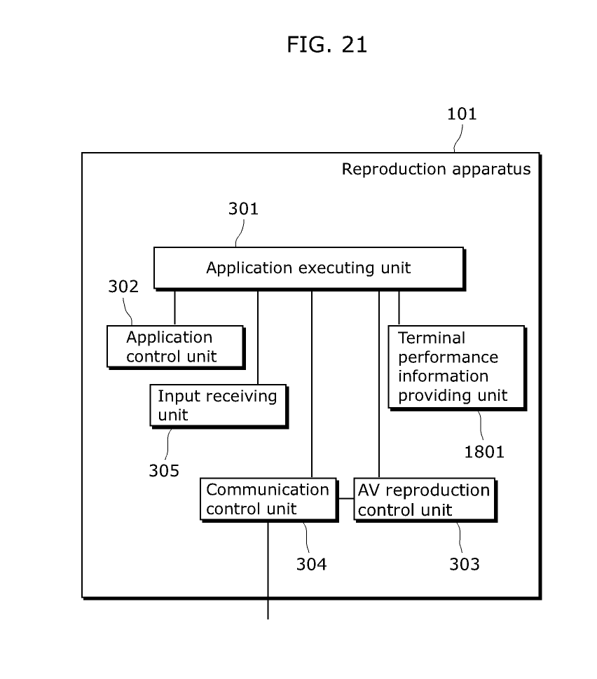

FIG. 21 is a diagram illustrating an internal configuration of the reproduction apparatus 101 according to Embodiment 3 of the present invention. It is to be noted that constituent elements identical to constituent elements described with reference to FIG. 3 are provided with the same numerical references and description for them will be omitted.

The reproduction apparatus 101 further includes a terminal performance information providing unit 1801 in addition to the constituent elements described with reference to FIG. 3.

The terminal performance information providing unit 1801 corresponds to a performance information providing unit according to an embodiment of the present invention, and has a function of providing a program caused to operate by the application executing unit 301 with information indicating performance of the reproduction apparatus 101. As a method of providing a function, there are, for example, a method of providing as an API, a method of storing data written in a predetermined format in the reproduction apparatus 101, and so on.

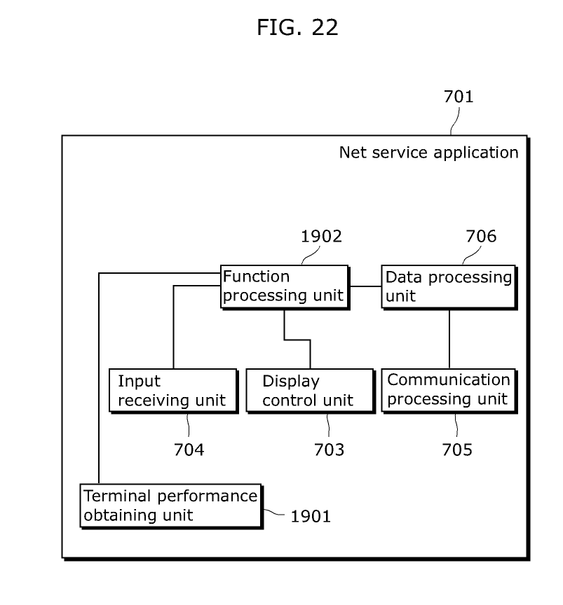

FIG. 22 is a diagram illustrating an internal configuration of a net service application 701 according to Embodiment 3 of the present invention. It is to be noted that constituent elements identical to constituent elements in FIG. 10 are provided with the same numerical references and description for them will be omitted.

A terminal performance obtaining unit 1901 obtains information related to performance of the reproduction apparatus 101 from the terminal performance information providing unit 1801 of the reproduction apparatus 101, which is described with reference to FIG. 21, and transmits the obtained information to the function processing unit 1902.

The function processing unit 1902 is capable of performing a processing based on the details transmitted by the terminal performance obtaining unit 1901, in addition to the processes performed by the function processing unit 702 illustrated in FIG. 10.

More specifically, in the case where the information related to performance of the reproduction apparatus 101 transmitted by the terminal performance information providing unit 1901 includes information related to a type of video data that is reproducible by the reproduction apparatus 101, the function processing unit 1902 is capable of classifying contents into a content that is reproducible by the reproduction apparatus 101 and a content that is irreproducible, using content information received from the link server 201 or the service server 202. According to the configuration described above, the function processing unit 1902 is capable of deleting the irreproducible content from a list of contents as illustrated as the GUI 1001 in FIG. 13, or ignoring even when the irreproducible content is selected.

### Embodiment 4

In Embodiment 3, the net service application 701 uses the terminal performance information providing unit 1801 to select, or the like, a content to be presented to a user; however, when the same processes are performed every time data is obtained by the link server 201 or the service server 20, the processes involve processing load on the reproduction apparatus 101. There is a problem that the processing load leads to deterioration of responding performance and increase in the hardware resource of the reproduction apparatus 101 used by the application.

In Embodiment 4 according to the present invention, a part of the processes performed by the application in Embodiment 3 is performed by the link server, thereby solving this problem.

According to Embodiment 4 of the present invention, in the requesting process (S1104) of requesting from the reproduction apparatus 101 to the link server 201 in the process procedure described with reference to FIG. 14 in Embodiment 1, information related to performance of the reproduction apparatus 101 obtained by the net service application 701 using the terminal performance information providing unit 1801 is included in a part of the details transmitted from the reproduction apparatus 101 to the link server 201. In addition, in the process of searching the stored data (S1111) and the process of transmitting data to the reproduction apparatus 101 (S1113), the link server 201 is capable of transmitting data to the reproduction apparatus 101 after deleting information of content that can be determined as irreproducible with the performance of the reproduction apparatus 101. According to the configuration described above, since the reproduction apparatus 101 has received information corresponding to the state after the selecting process described in Embodiment 3 is carried out in the process of receiving data from the link server 201 (S1105), it is not necessary to perform selecting process in the subsequent processes performed in the reproduction apparatus 101. In addition, there is no change in the information related to performance provided by the terminal performance information providing unit 1801, in general as long as there is no change in the program that operates on the reproduction apparatus 101. Therefore, it is possible, for example, to include the information related to performance into a request not every time but only once at any point in time in the process of S1104. The link server 201 or the service server 202 which is received the request is capable of holding the performance information and using the performance information from the next request onward as well. With this, it is possible to further reduce the processes of the net service application in the reproduction apparatus 101.

It is to be noted that in the case where the link server 201 or the service server 202 provides a service to plural reproduction apparatuses 101 each having different performance, it is necessary to identify the requestor. The link server 201 or the service server 202 is capable of identifying the requestor by including information for identifying the reproduction apparatus 101, in the IP address of the requestor or the details of the request in each time.

### Embodiment 5

In Embodiment 5 according to the present invention, a method will be described which changes an application that operates on the reproduction apparatus in the case where a there is a failure in the net service application or there is a change in a specification.

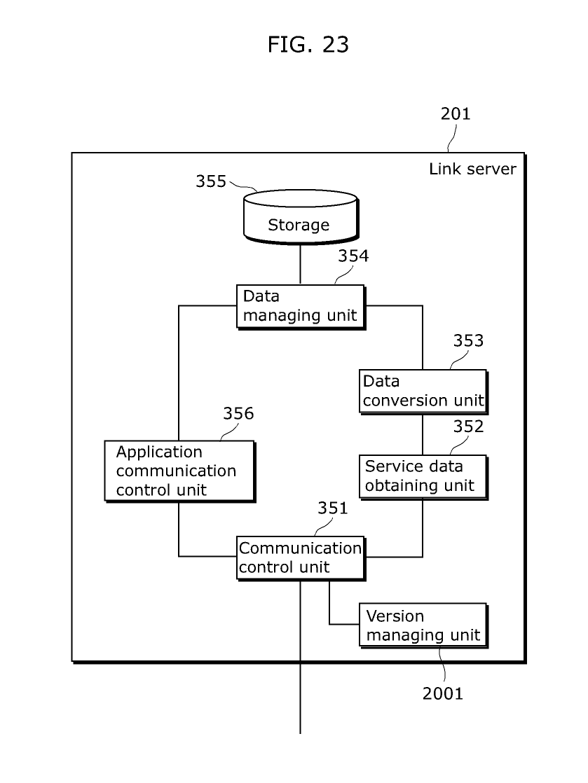

FIG. 23 is a diagram illustrating an internal configuration of the link server 201 according to Embodiment 5 of the present invention. It is to be noted that constituent elements identical to those in the internal configuration described with reference to FIG. 4 are provided with the same numerical references and description for them will be omitted. The link server 201 further includes a version managing unit 2001. The version managing unit 2001 manages which version is of the net service application can use the link server 201. In addition, the version managing unit 2001 is also capable of providing a net service application that can use the link server 201 in response to a request from the reproduction apparatus 101.

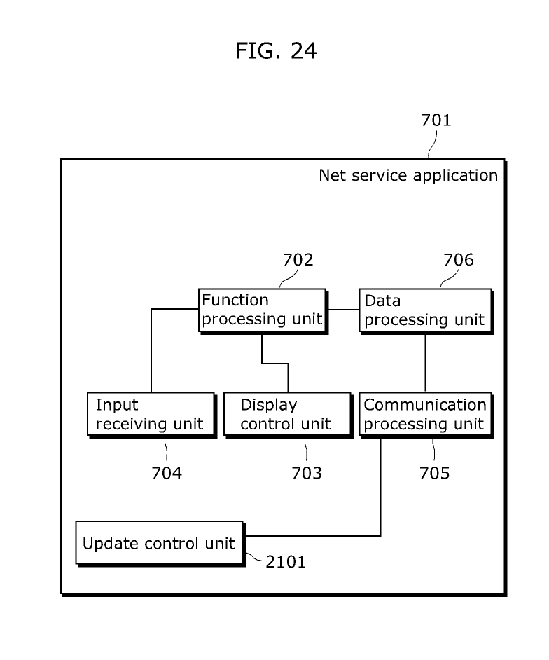

FIG. 24 is a diagram illustrating an internal configuration of a net service application 701 according to Embodiment 5 of the present invention. It is to be noted that constituent elements identical to those in the internal configuration described with reference to FIG. 10 are provided with the same numerical references and description for them will be omitted.

An update control unit 2101 corresponds to a program updating unit according to an embodiment of the present invention, knows the version of the net service application 701, and communicates with the link server 201 using the communication processing unit 705. The update control unit 2101 is capable of notifying the link server 201 of its own version, and obtaining the version of a corresponding net service application from the version managing unit 2001 of the link server 201. In addition, the update control unit 2101 is capable of obtaining a program of the net service application from the link server 201. For example, the update control unit 2101 is capable of replacing the net service application 701 stored in the reproduction apparatus 101 with the net service application 701 obtained from the link server 201 in the case where the version obtained from the link server 201 is different from the version of its own. This enables update of the net service application 701.

The following describes an example of the method of replacing the net service application 701. Here, the net service application stored, at a certain point in time, in the reproduction apparatus 101 is referred to as an old application and an application obtained from the link server 201 is referred to as a new application. The update control unit 2101 of the old application, upon obtaining a new application from the link server 201, stores the obtained new application into a predetermined storage medium in the reproduction apparatus 101. When the storing is completed, the update control unit 2101 notifies the application executing unit 301 of the reproduction apparatus 101 of the completion of preparation of the new application, and instructs to execute the new application at the time when the application executing unit 301 executes a net service application next time. The application executing unit 301 which is provided with the instruction may immediately end execution of the old net service application or may merely store that the instruction has been provided, without ending the execution of the old net service application.

When a net service application is activated in response to an instruction from the user after the old net service application ended at an arbitrary point in time, the application executing unit 301 activates not the old application but the new application.

It is to be noted that the reproduction apparatus 101 may delete the program of the old application when it is determined that the program of the old application is no longer necessary. In addition, the old application may be kept stored in view of the need to be returned to the old application when there is a failure in the new application.

It is to be noted that the function of updating the entire program of the reproduction apparatus 101 is provided with a general CE device as a known technique. The update of only the program of the net service application has been described in the present embodiment; however, it is also possible to update the net service application by using a function of updating the entire program and including therein a new net service application.

In addition, although the case where the old net service application obtains the new net service application from the link server 201 has been described, the application executing unit 301 may obtain the new net service application from the link server 201. With this, it is possible to update the net service application when the net service application is not executed, or when execution of the net service application became impossible for some reason. In this case, the application executing unit 301 has the function corresponding to the update control unit 2101. In addition, the application executing unit 301 needs to know in advance a method of transmitting information with the version managing unit 2001 of the link server 201. In addition, when the application executing unit 301 obtains a new net service application from the link server 201, it is possible to inquire, to the version managing unit 2001, whether or not the net service application has been updated at the time of activating the reproduction apparatus 101 or at an arbitrary point in time, for example, to obtain a new net service application if there has been an update, and to thereafter activate the new net service. According to the configuration described above, it is possible to execute always the latest net service application.

### Embodiment 6

In Embodiment 6 according to the present invention, a method for addressing the following cases will be described: the case where a user desires viewing of a new net service; the case where reproduction of the net service becomes impossible from a certain point in time due to, for example, addition of a function of the service server, or a change in the specification; and so on.

The first method is a method of changing the processes in the link server 201, and the second method is a method of changing the net service application 701 and implemented using the method of updating the net service application 701 as described in Embodiment 5.

First, the first method will be described. In the case where the details of change in the service server 202 indicate, for example, a change in the procedure or method of requesting for data obtainment, it is only necessary to change, according to the change in the service server 202, the service data obtaining unit 352 shown in FIG. 4. This eliminates the need to change a process in other constituent elements. In addition, in the case where the details of change in the service server 202 indicate, for example, a change in the details of data obtained from the service server 202, the data conversion unit 353 is changed, thereby preventing a change in the result of conversion performed by the data conversion unit 353. This eliminates the need to change a process in other constituent elements.

Next, the second method will be described. There arises a need to change the net service application 701 when there is a change in the procedure, method or details of the request between the link server 201 and the net service application 701 due to the use of the first method. In addition, in the case where the net service application 701 directly communicates with the service server 202 without routing through the link server 201, it is necessary to change the net service application 701 according to the change in the service server 202.

For example, in the case where the details (format, configuration, and the like) of data obtained from the link server 201 or the service server 202, it is necessary to change, according to the details of change, the data processing unit 706 illustrated in FIG. 10. In addition, when transmitting a request to the link server 201 or the service server 202, the format is converted into a format that can be interpreted by the link server 201 or the service server 202, and it is necessary to change the conversion process when the format is changed.

In addition, there is a case where the GUI displayed on the display 103 needs to be changed in such a case as there is a significant increase in the function provided by the service server 202. As a general programming technique, the net service application 701 is provided with a function of displaying the GUI according to data related to a screen configuration and a function of obtaining the data related to the screen configuration from the outside (the link server 201, for example), thereby making it possible to change the GUI without changing the net service application 701. In addition, in the case where it is necessary to change the net service application 701, changing the display control unit 703 or the function processing unit 702 is required in some cases.

It is to be noted that, in such a case where a user desires viewing of a new net service, or a case where reproduction of the net service becomes impossible from a certain point in time due to, for example, addition of a function of the service server, or a change in the specification, it is possible to address the situation by using one of the first method and the second method, or the both.

It is to be noted that, it is sufficient to change only the link server 201 according to the first method; however, there arises a need to update all of the net service applications 701 that operate on the respective reproduction apparatuses 101 which use the link server 201 when the second method is used. Therefore, it is desirable to implement only using the first method, in view of the overall costs and the convenience of the user. In addition, the possibility of implementation only by the first method increases, by reducing, in advance, the processes as much as possible, in which the net service application 701 directly communicates with the service server 202.

It is to be noted that the present invention produces an advantageous effect also in that it is possible to be implemented only with the first method to overcome the problem described in the embodiments above.

### Embodiment 7

In Embodiments 1 to 6, when the net service application 701 is executed on the reproduction apparatus 101, the net service application 701 performed processing of some kind that accompanies an operation by a user and communication with the link server 201 or the service server 202. However, once the net service application 701 is quitted, the history and settings based on the preference of a user cannot be used for the next operation. This can be the cause of decrease in the operability for the user and disincentive to increasing of the efficiency.

In Embodiment 7 according to the present invention, the problem described above is solved by adding, to the reproduction apparatus 101, the configuration that enables storing of information in response to an instruction from the net service application 701.

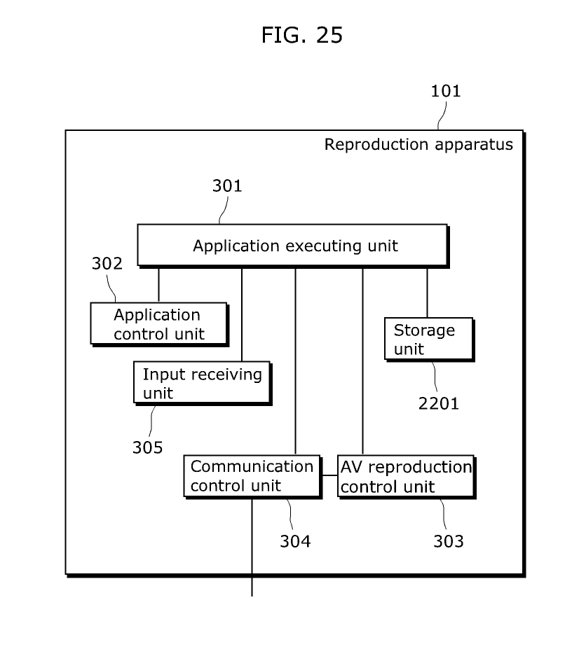

FIG. 25 is a diagram illustrating an internal configuration of the reproduction apparatus 101 according to Embodiment 7 of the present invention. It is to be noted that constituent elements identical to those in the internal configuration described with reference to FIG. 3 are provided with the same numerical references and description for them will be omitted.

The reproduction apparatus 101 further includes a storage unit 2201 capable of holding the information transmitted by the net service application 701 and transmitting the held information to the net service application 701 in response to a request from the net service application 701. The storage unit 2201 corresponds to an information holding unit according to an embodiment of the present invention. It is to be noted that, this storage unit 2201 can be implemented as long as being a medium capable of storing data, such as a hard disk, a non-volatile memory, and a volatile memory. In addition, it is desirable that the storage unit 2201 is a non-volatile storage medium in which information remains even after the power of the reproduction apparatus 101 is turned off. In addition, the storage unit 2201 does not always have to be provided in the reproduction apparatus 101 and may be connected to the outside of the reproduction apparatus 101 as long as the storage unit 2201 is a storage unit that can be used by the reproduction apparatus 101.

The net service application 701 is capable of storing, in the storage unit 2201, information related to (i) the details set by a user, such as the color combination of the GUI, the size of characters, and individual information of the user, (ii) the type or history of the selected net service, (iii) the type or history of the selected content, and so on The net service application 701, at the time of activation, searches the storage unit 2201 for information stored by the net service application 701 itself, and obtains the information from the storage unit 2201 when the information is found. According to the configuration described above, the net service application 701 is capable of performing the process for increasing the convenience for the user, according to information such as the settings of the user and history of the past, using the details.

It is to be noted that, in the case where the link server 201 or the service server 202 has the function corresponding to the storage unit 2201, that is, where the link server 201 or the service server 202 has the function of receiving, from the net service application 701, a request to record information and obtain the recorded information, the net service application 701 is capable of implementing the same advantageous effect without using the storage unit 2201, in other words, without including the storage unit 2201 in the reproduction apparatus 101.

### Embodiment 8

In Embodiment 1, it has been described that there is the case where the AV reproduction control unit 303 obtains data using the communication control unit 304. However, the obtainment is time-consuming in some cases due to the effects of the speed of the communication line and the speed and the like of the link server 201 and the service server 202. This results in not only impairing the convenience for a user but also increasing the costs required for communication.

According to Embodiment 8 of the present invention, the data obtained by the AV reproduction control unit 303 is stored in the reproduction apparatus 101, and the data stored in the reproduction apparatus 101 is used when there arises a need for obtaining the same data, instead of obtaining data using the communication control unit 304, thereby solving the above-described problems.

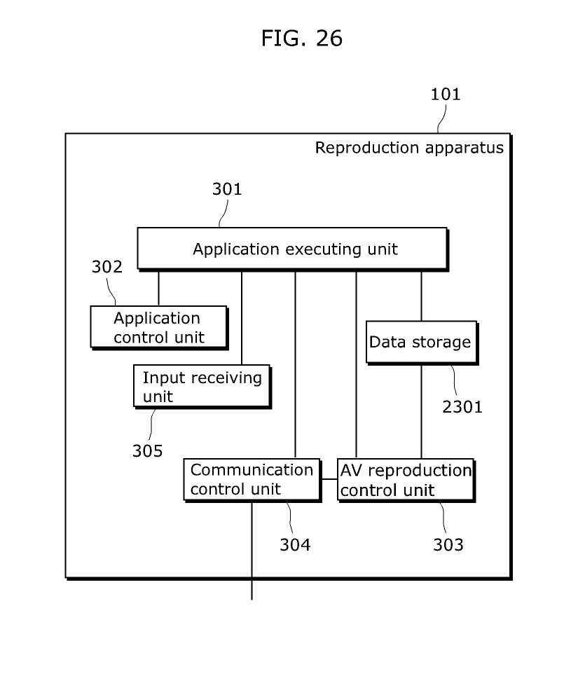

FIG. 26 is a diagram illustrating an internal configuration of the reproduction apparatus 101 according to an embodiment of the present embodiment. It is to be noted that constituent elements identical to those in the internal configuration described with reference to FIG. 3 are provided with the same numerical references and description for them will be omitted.

The reproduction apparatus 101 further includes a data storage 2301. The data storage 2301 is capable of storing, retrieving, deleting, changing, and so on, of data to be reproduced by the AV reproduction control unit 303 (hereinafter referred to as reproduction data) and information related to a source for obtainment of the reproduction data. It is to be noted that the information related to the source for obtainment of the reproduction data is such information as an identifier (a domain name, an IP address, and the like) of a server that is the source for obtainment, and a file identifier in the server, and is stored in a URL format, for example.

The AV reproduction control unit 303, upon receiving a request for reproduction from the net service application 701, determines whether or not reproduction data needs to be obtained from the server. When it is not necessary to obtain the reproduction data from the server, processes same as the processes in Embodiment 1 are performed. When it is necessary to obtain the reproduction data from the server, the AV reproduction control unit 303 checks whether or not the data which is necessary to be obtained from the server is stored in the data storage 2301, based on the information related to the source for obtainment. When the data is stored, the AV reproduction control unit 303 reproduces the reproduction data obtained from the data storage 2301, instead of obtaining data from the server. When intended reproduction data is not stored in the data storage 2301, the AV reproduction control unit 303 obtains reproduction data from the server and reproduces the reproduction data, and in parallel with this, stores the reproduction data obtained from the server into the data storage 2301. At this time, the information related to the source for obtainment is paired and stored together as information for identifying the reproduction data which is stored. The configuration described above allows the AV reproduction control unit 303 to obtain reproduction data from the data storage 2301 in response to a request for reproduction to the same source for obtainment, from the next time onward.

### Embodiment 9

In Embodiment 1, it has been described that the net service application communicates with the link server 201. However, when there is only one link server 201, the load on the link server 201 increases in some cases. In addition, in the case where an error occurs in the link server 201, reproduction of the net service cannot be performed in some cases.

In addition, in the case where (i) a user desires to view a new net service or (ii) adding a function or changing the specification of the service server is to be addressed, by performing the first method described in Embodiment 6; that is, the processes in the link server 201, there is a possibility that the net service cannot be reproduced by the reproduction apparatus 101 during the time in which the link server 201 is changed.

In order to solve the above-described problems, a method will be described, with which the net service application uses plural link servers 201, so that reproduction of a net service in the reproduction apparatus 101 is implemented, according to Embodiment 9.

First, the following describes the case where load distribution of the link server 201 is aimed at. In addition, it is assumed that the net service application knows in advance plural references as the link server 201. The net service application may know these plural references from the beginning, or may dynamically obtain information related to a reference from the link server 201 that can be used at the time during an operation of the net service application. The net service application is capable of switching, by performing a predetermined sorting process, the link server 201 to be accessed, according to the details of a request to the link server 201, timing, priority, or a load condition of the link server. As described above, the net service application accesses plural different link servers 201 instead of always accessing only one link server 201, and thus it is possible to reduce the load per a link server 201.

Next, processes for updating the link server 201 will be described. When updating the link server 201, it is necessary, in general, to stop an access from the reproduction apparatus 101 even for a short amount of time. In the case where the first link server 201 becomes unavailable at a certain point in time while the net service application uses the first link server 201, for example, the net service application tries to access another link server which is known in advance; that is, the second link server 201. When updating the link server 201, the update is carried out at different points in time between the first link server 201 and the second link server, thereby allowing maintaining the state where at least one of the link servers 201 can be accessed. It is to be noted that, in the case where the net service application knows in advance when the first link server 201 is unavailable for access, it is also possible to access the second link server 201 without accessing the first link server 201 during the time period.

It is to be noted that there is a technique, as a known technique related to a server, for allowing plural servers to be perceived, to a reproduction apparatus 101 that accesses the server, as being only one server and as properly operating, even when a part of servers stops. It is possible to solve the problem using the technique as well. However, although this technique is useful mainly for load distribution, it is difficult for servers having different functions to be present together, in updating the server function. Thus, in that regard, the method for solving the problem according to the present embodiment is useful.

### Embodiment 10

In Embodiment 1, it has been described that the link server 201 provides information according to a request from the reproduction apparatus 101; however, there is the case where it is desired to change the information to be provided by the link server 201, according to the type of the reproduction apparatus 101 that is the requestor of the information. The case is, for example, the case where it is desired to change to-be-provided information according to the company that manufactured the reproduction apparatus 101, the case where it is desired to change to-be-provided information for each of the types of the apparatuses even they are manufactured by the same manufacturing company, the case it is desired to change to-be-provided information according to information attached to peripheral devices provided to the reproduction apparatus 101, and so on. It is possible to allow the reproduction apparatus 101 to provide more optimized information, by changing to-be-provided information according to the type of the reproduction apparatus 101.

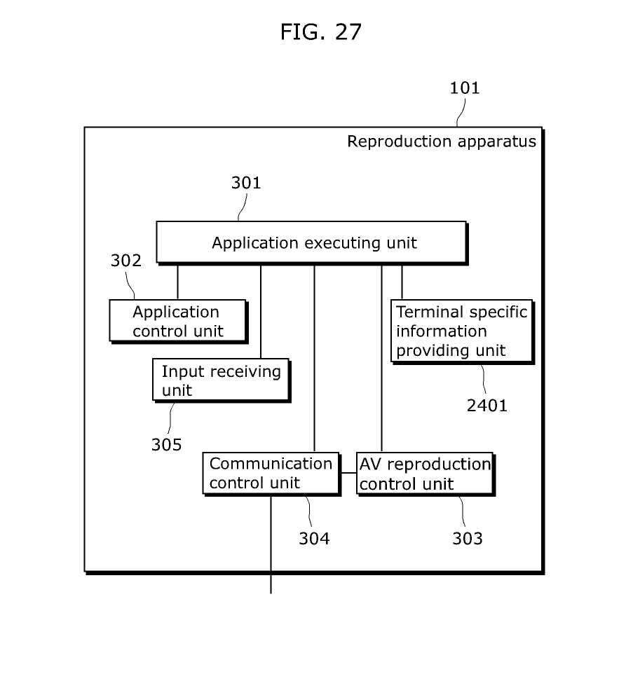

FIG. 27 is a diagram illustrating an internal configuration of the reproduction apparatus 101 according to Embodiment 10 of the present invention. It is to be noted that constituent elements identical to those in the internal configuration described with reference to FIG. 3 are provided with the same numerical references and description for them will be omitted.

The reproduction apparatus 101 further includes a terminal specific information providing unit 2401.

The terminal specific information providing unit 2401 corresponds to a specific information providing unit according to an embodiment of the present invention, and is capable of providing the net service application with specific information held by the reproduction apparatus 101. The specific information is information indicating the manufacturer, the type name and a model number, a version number of a program, information related to peripheral devices, and so on, of the reproduction apparatus 101. In addition, the information related to peripheral devices is information indicating the size and the performance such as resolution of the display 103, information that can be obtained from an identification device when the identification device such as an IC card is provided, and so on.

The net service application notifies at least once the link server 201 of the specific information obtained from the terminal specific information providing unit 2401. The configuration described above allows the link server 201 to obtain information related to the reproduction apparatus 101 and change the information to be transmitted, according to the reproduction apparatus 101.

It is to be noted that the net service application may transmit, to the link server 201, specific information in response to a request every time, or may transmit the specific information only once. In addition, the link server 201 may store, as a pair, the information and information attached to a request every time, such as an IP address of the requestor, and search for specific information based on the information attached to a request every time and change information to be transmitted, based on the specific information, for a subsequent request.

### Embodiment 11

In Embodiment 1, the case has been described where, when reproducing a net service, the net service application mostly plays a key roll in reproduction processing. However, there is also the case where a program other than the net service application (hereinafter referred to as a second program) operates in the reproduction apparatus 101. For example, there is the case where the second program itself has a function equivalent to a function of the net service application, and the second program also plays a key roll in the process of reproducing a net service of some kind. In such a case, a second program executing unit included in the reproduction apparatus 101 causes the second program to operate. For example, when a net service application performs the processes of presenting the display of the GUI 901 illustrated in FIG. 12 and receiving the selection of a user, reproduction cannot be carried out by the net service application itself, but it is possible, when the net service application knows net services available to a user, to list the net services on the GUI 901 by requesting the second program for reproduction.

In addition, in the case where, even when the net service application plays a key roll in reproduction processing, the second program implements the function that cannot be implemented by the net service application itself, the second program is executed in some cases in order to transfer part of the processes of reproducing a net service to the second program.

According to Embodiment 11 of the present invention, the application executing unit 301 of the reproduction apparatus 101 further has a function of receiving, from a net service application, information for identifying the second program and information to be transmitted to the second program, a function of executing the second program based on the information received, and a function of transmitting, to the second program, the information transmitted by the net service application. The application executing unit 301 further has a function of transmitting information to the net service application in response to an instruction from the second program, and a function of controlling a life cycle such as activating or ending the net service application.

The following describes the case where the second program is capable of reproducing a net service and the net service (hereinafter referred to as a second net service) that can be reproduced by the second program is selected by a user. Upon detecting that the second net service is selected, the net service application instructs the application executing unit 301 to execute the second program. At this time, the net service application may attach information related to preference, settings, history, and so on to the instruction. Then the application executing unit 301 activates the second program in response the instruction from the net service application, and instructs reproduction of the second net service. The activated second program performs reproduction of the second net service. Here, the application executing unit 301 ends the net service application. According to the configuration described above, it is possible to suppress hardware resource consumption due to continuous execution of plural programs having a similar function. Furthermore, when it is desired to cause the second program to end the reproduction of the second net service and to transit to the screen of GUI 901, the application executing unit 301 ends the second program and transfer the processes to the net service application. In addition, when executing the second program, the application executing unit 301 activates the net service application in the case where the net service application is ended. In addition, in the case where there is the information that should be transmitted from the second program to the net service application, the application executing unit 301 is also capable of transmitting the information to the net service application.

It is to be noted that, the methods of transmitting information between the net service application and the second program via the application executing unit 301 include a method of transmitting an argument of API or a method of transmitting via a recording medium that can be used commonly by the net service application and the second program, and an embodiment of the present invention can be implemented with any of the methods.

### Embodiment 12

In Embodiment 1, the case has been described where a list of net services provided by the net service application is displayed as the GUI 901 to prompt a user to select from the list; however, there are cases where, even if the net service application supports reproduction of plural net services, it is desired, as a function of the reproduction apparatus 101, that only part of the net services can be selected. The cases include, for example, the case where it is desired to differentiate the reproduction apparatuses from each other according to intent of a manufacturer, the case where a net service uses comparatively lots of hardware resources, the case where it is known in advance that the net service cannot be reproduced by a reproduction apparatus of a lower-cost version, and so on. In the case where an image is displayed as in GUI 901 in the above-described cases, there is a possibility of creating confusion to the user.

In view of the above, in Embodiment 12 according to the present invention, a method is described with which the reproduction apparatus 101 transmits, to the net service application, which of the net services, among the net services that can be reproduced by the net service application, is to be presented to a user.

The application executing unit 301 illustrated in FIG. 3 executes a net service application, and is capable of transmitting, to the net service application, which net service is to be reproduced by the reproduction apparatus 101. To be more specific, the application executing unit 301 has: the function of transmitting using an argument of the time of activation; the function of changing setting data when the setting data is present which is known to be used by the net service application at the time of execution; or the function of replying whether or not the net service is to be reproduced in response to an inquiry from the net service application, thereby enabling implementation.

In the case where the net service application can determine, in any of the methods, a net service to be reproduced by the reproduction apparatus 101, the net service application is capable of deleting, from a list, a net service not to be reproduced in the display of the GUI 901 illustrated in FIG. 12, for example.

Here, it is desirable to configure, as a single system LSI, the portion including a logical element as a main portion, excepting (i) a mechanistic constituent element (a BD drive, a removable medium drive, and a built-in media drive) and (ii) a constituent element mounted by a memory with a large capacity (a video plane and a graphics plane) from hardware constituting the reproduction apparatus 101 described in Embodiments 1 to 12. The reason for this is because the portion having the logical element as a main portion can be densely integrated.

The system LSI is configured by mounting a bare chip on a substrate with high density and packaging the same. The bare chips having an appearance structure which looks seemingly like a single LSI, as a result of being mounted on a substrate with high density and packaged, are also included in a system LSI. Such a system LSI is referred to as a multi chip module.

Focusing attention on a type of a package for the system LSI, there are types called a QFP (quad flat package) and a PGA (pin grid array). The QFP is a system LSI in which a pins are attached to four side surfaces of a package. The PGA is a system LSI in which lots of pins are attached to the overall bottom surface.

These pins play a roll as an interface with other circuits. The pins in the system LSI play such an interface roll, and thus the system LSI plays a core roll in the reproduction apparatus 101, by connecting the pins in the system LSI to another circuit.

The system LSI can be incorporated into, not to mention the reproduction apparatus 101, but also a TV, a game, a personal computer, a mobile phone with a TV receiving function, and a variety of devices which are used for video reproduction, and thus it is possible to broaden the application of the present invention.

In addition, in the case where an elementary buffer, a video decoder, an audio decoder, and a graphics decoder are also integrated as a single system LSI, it is desirable that the architecture of the system LSI is in conformity to a UniPhier architecture.

The system LSI in conformity to the UniPhier architecture includes a circuit block described below.

### Data Parallel Processor (DPP)

This is an SIMD type processor in which plural element processors perform the same operation. The SIMD type processor causes computing units included in the respective element processors to operate simultaneously with a single instruction so that decoding processing to plural pixels included in a picture is performed in parallel.

### Instruction Parallel Processor (IPP)

This processor includes: a “Local Memory Controller” that includes an instruction RAM, an instruction cash, a data RAM, and a data cash; a “Processing Unit” that includes an instruction fetching unit, a decoder, an executing unit, and a register file; and a “Virtual Multi Processor Unit” that causes the processing unit to execute plural applications in parallel.

### MPU Block

This block includes: a peripheral circuit such as an ARM core, an external bus interface (Bus Control Unit: BCU), a DMA controller, a timer, a vector interrupt controller, and so on; and a peripheral interface such as UART, GPIO (General Purpose Input Output), a synchronous serial interface, and so on.

### Stream I/O Block

The stream I/O block performs inputting and outputting of data with a driving apparatus, a hard removable medium driving apparatus, and an SD memory card driving apparatus, which are connected to an external bus, via an USB interface or an ATA Packet interface.

### AV I/O Block

The AV I/O block includes an audio input and output, a video input and output, and an OSD controller, and performs inputting and outputting data with a TV or an AV amplifier.

### Memory Control Block

The memory control block is a block that implements reading and writing of an SD-RAM connected through the external bus, and includes: an internal bus connecting unit that controls internal connection between the blocks; an access control unit that performs transferring of data with the SD-RAM connected to the outside of the system LSI; and an access scheduling unit that adjusts an SD-RAM access request from each of the blocks.

The following describes a specific production procedure in detail. First, a circuit diagram of the portion to be a system LSI is created based on a configuration diagram illustrated in each of the embodiments, and implements constituent elements in the configuration diagram using a circuit element, an IC, or an LSI.

While implementing each of the constituent elements, a bus that connects between the circuit element, the IC, or LSI, a peripheral circuit, an interface to the outside, and so on, are defined. Furthermore, a connection line, a power line, a ground line, a clock signal line, and the like, are defined. In defining the above, the circuit diagram is completed while adjusting an operation timing of each of the constituent elements and adding adjustment such as ensuring a band width that is necessary for each of the constituent elements, in view of the specification of the LSI.

When the circuit diagram is completed, implementation design is carried out. The implementation design refers to the processing of creating a substrate layout that determines where the components (the circuit element, the IC or the LSI) on the circuit diagram created in the circuit designing are to be disposed on the substrate, or how the connection line on the circuit diagram is wired on the substrate.

When the implementation design is carried out as stated above and the layout on the substrate is determined, a result of the implementation design is converted into CAM (Computer Aided Manufacturing) data and outputted to equipments such as an NC (Numerical Control) machine tool. The NC machine tool performs SoC implementation or SiP implementation based on the CAM data. The SoC (System on Chip) implementation is a technique of photolithographing plural circuits on a single chip. The Sip (System in Package) implementation is a technique of packing plural chips into a single package using a resin or the like. Through the processes described above, the system LSI according to an embodiment of the present invention can be generated based on an internal configuration diagram of the reproduction apparatus 101 illustrated in each of the embodiments.

It is to be noted that, an integrated circuit generated as described above is also referred to as an IC, an LSI, a super LSI, and an ultra LSI according to the degree of integration.

In the case where an FPGA (Field-Programmable Gate Array) is used for implementing the system LSI, a number of logic elements are arranged in a grid, and lines in rows and columns are connected based on the combination of input and output described in the LUT (Look Up Table), thereby implementing the hardware configuration described in each of the embodiments. The LUT is stored in the SRAM. Since the stored data in the SRAM is deleted when the power is turned off, it is necessary, when using the FPGA, to write, into the SRAM, the LUT that implements the hardware configuration described in each of the embodiments, according to the definition of configuration information.

In addition, a processor such as the CPU may execute a program to implement a part of the functions included in the net service reproduction system according to an embodiment of the present invention.

In addition, the present invention may be implemented as the above-described program, or may be a non-transitory computer readable recording medium on which the above-described program is recorded. It should be understood that the above-described program can be distributed via a transmission medium such as the Internet.

In addition, at least part of the functions of the net service reproduction system and the modifications thereof according to the embodiments described above may be combined.

In addition, the numbers stated above are presented only for specifically describing the present invention, and thus the present invention is not limited by the numbers exemplified.

Furthermore, the order for executing the above-described steps are used only for specifically describing the present invention, and thus an order other than the above-described order may be used. In addition, part of the above-described steps may be executed with the other step at the same time (in parallel).

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The net service reproduction apparatus according to the present invention can be manufactured and sold managerially, continuously, and repetitively in the manufacturing industry. In particular, the present invention can be used in the movie and broadcasting industries involved with network distribution of video contents, and consumer equipment industries.

1. A server comprising:
an information obtaining unit configured to obtain first data having a first format from an external server that provides, through an electric telecommunication line, data stored in a database;
an information conversion unit configured to convert the first data into second data having a second format that is available to a program that operates on a reproduction apparatus; and
an information transmitting unit configured to transmit, to the program that operates on the reproduction apparatus, the second data resulting from the conversion performed by said information conversion unit.

2. The server according to claim 1,
wherein said information conversion unit is configured to convert, into the second data having the second format, data having a plurality of different formats which include the first format.

3. The server according to claim 1,
wherein data having the first format cannot be reproduced by the reproduction apparatus and data having the second format can be reproduced by the reproduction apparatus.

4. The server according to claim 1, further comprising
a request receiving unit configured to receive a request from the program that operates on the reproduction apparatus,
wherein, according to the request received by said request receiving unit:
said information obtaining unit is configured to obtain the first data from the external server;
said information conversion unit is configured to convert the first data into the second data; and
said information transmitting unit is configured to transmit the second data to the program.

5. The server according to claim 1, further comprising
an information storage for storing and retrieving data,
wherein said server stores, into said information storage, the second data resulting from the conversion performed by said information conversion unit.

6. The server according to claim 5, further comprising
a request receiving unit configured to receive a request from the program,
wherein (i) when the second data specified by the request received by said request receiving unit is stored in said information storage, said information transmitting unit is configured to transmit, to the program that operates on the reproduction apparatus, the second data stored in said information storage, and
(ii) when the second data specified by the request received by
said request receiving unit is not stored in said information storage:
said information obtaining unit is configured to obtain the first data from the external server;
said information conversion unit is configured to convert the first data into the second data; and
said information transmitting unit is configured to transmit, to the program that operates on the reproduction apparatus, the second data resulting from the conversion performed by said information conversion unit.

7. A reproduction apparatus comprising:
a program executing unit configured to execute a program for receiving second data having a second format through an electric telecommunication line from a server that converts first data having a first format into the second data, the first data being obtained, by the server, from an external server through the electric telecommunication line;
a communication unit configured to transmit and receive information to and from the external server connected through the electric telecommunication line, based on an instruction from the program executed by said program executing unit; and
a display unit configured to construct a display image to be presented to a user, based on the instruction from the program executed by said program executing unit.

8. The reproduction apparatus according to claim 7,
wherein the program is written in an abstract language independent of a configuration of said reproduction apparatus, and
said program executing unit includes a virtual machine capable of executing a program written in the language.

9. The reproduction apparatus according to claim 7, further comprising
an error notification unit configured to notify the program of failure in properly displaying the display image when said display unit fails to properly display the display image.

10. The reproduction apparatus according to claim 7, further comprising
a performance information providing unit configured to provide the program with information related to performance of said reproduction apparatus.

11. The reproduction apparatus according to claim 7, further comprising
a program updating unit configured to replace the program stored in said reproduction apparatus with an other program when the program is updated.

12. The reproduction apparatus according to claim 7, further comprising
an information holding unit configured to hold, in said reproduction apparatus, information transmitted by the program.

13. The reproduction apparatus according to claim 7, further comprising
a data storage which stores, in said reproduction apparatus, data obtained from the external server.

14. The reproduction apparatus according to claim 7, further comprising
a specific information providing unit configured to supply the program with specific information held by said reproduction apparatus,
the specific information being for identifying a difference between said reproduction apparatus and an other reproduction apparatus.

15. The reproduction apparatus according to claim 7,
wherein a second program different from the program is further held, and
said reproduction apparatus further comprises a second program executing unit configured to execute the second program based on the instruction from the program.

16. An information reproduction system comprising:
a first server which stores data in a database and provides, through an electric telecommunication line, first data having a first format and stored in the database;
a second server which converts the first data into second data having a second format and provides the second data, the first data being obtained, by the second server, from said first server through the electric telecommunication line; and
a reproduction apparatus which reproduces data obtained from said first server, using data obtained, by the reproduction apparatus, from said second server,
wherein said reproduction apparatus includes a program executing unit configured to cause a program to operate, the program being for communicating with said first server and said second server and issuing an instruction on image display.

17. A non-transitory computer-readable recording medium for use in a computer, said recording medium having a computer program recorded thereon for causing the computer to execute:
obtaining first data having a first format from an external server that provides, through an electric telecommunication line, data stored in a database;
converting the first data into second data having a second format that is available to a program that operates on a reproduction apparatus; and
transmitting, to the program that operates on the reproduction apparatus, the second data resulting from the conversion performed in said converting.

18. A non-transitory computer-readable recording medium for use in a computer, said recording medium having a computer program recorded thereon for causing the computer to execute:
executing a program for receiving second data having a second format through an electric telecommunication line from a server that converts first data having a first format into the second data, the first data being obtained, by the server, from an external server through the electric telecommunication line;
transmitting and receiving information to and from the external server connected through the electric telecommunication line, based on an instruction from the program executed in said executing; and
constructing a display image to be presented to a user, based on the instruction from the program executed in said executing.
